(19) United States
(12) Patent Application Publication
(10) Pub. No.: US 2024/0354586 A1
(43) Pub. Date: Oct. 24, 2024

(54) MITIGATING AI NEGATIVE SIDE EFFECTS

(71) Applicant: Mark Cummings, Atherton, CA (US)

(72) Inventor: Mark Cummings, Atherton, CA (US)

(21) Appl. No.: 18/638,200

(22) Filed: Apr. 17, 2024

Related U.S. Application Data
(60) Provisional application No. 63/461,202, filed on Apr. 21, 2023.
(60) Provisional application No. 63/535,530, filed on Aug. 30, 2023.

(51) Int. Cl. G06N 3/092

(52) U.S. Cl. CPC G06N 3/092

(57) ABSTRACT

One or more objectives, one or more algorithms, and one or more constraints of an orchestrator with which a processor is associated is implemented. The orchestrator is associated with an AI-based algorithm. Based on one or more policies to improve a performance of the orchestrator, the orchestrator is moved to a different part of a system via a communication interface.

### CROSS REFERENCE TO OTHER APPLICATIONS

This application claims priority to U.S. Provisional Patent Application No. 63/461,202 entitled GENERATIVE AI USING ORCHESTRATORS AND/OR CONDUCTORS filed Apr. 21, 2023 and claims priority to U.S. Provisional Patent Application No. 63/535,530 entitled ORCHESTRATION OF OR WITH GENERATIVE AI filed Aug. 30, 2023, each of which is incorporated herein by reference for all purposes.

### BACKGROUND OF THE INVENTION

It is often the case that when new technology is introduced, the initial focus is on the benefits, and negative side effects are often not considered until later. This is often the case with information technologies. One aspect in information technologies that is often missed is that while new tools provide benefits, they can shift the balance of power from beneficial uses to pernicious uses while inadvertently causing other damages. The field of artificial intelligence (AI) is undergoing rapid evolution with new powerful capabilities emerging-both beneficial and negative. It is likely that this rapid evolution will continue increasing both positive and negative side effects.

### BRIEF DESCRIPTION OF THE DRA WINGS

Various embodiments of the invention are disclosed in the following detailed description and the accompanying drawings.

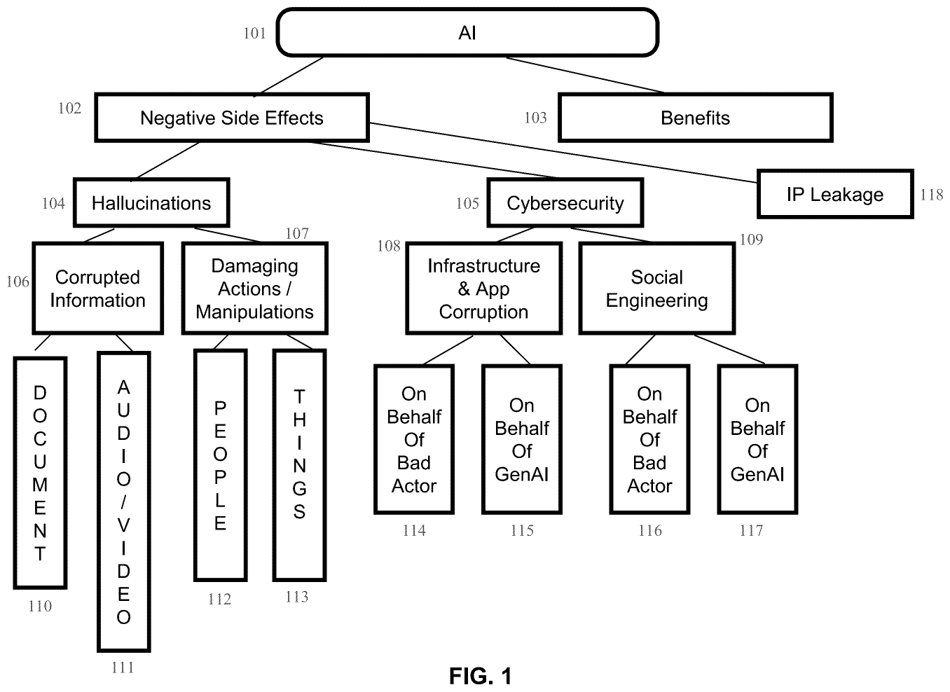

FIG. 1 is a diagram illustrating a taxonomy of negative side effects associated with AI in accordance with some embodiments.

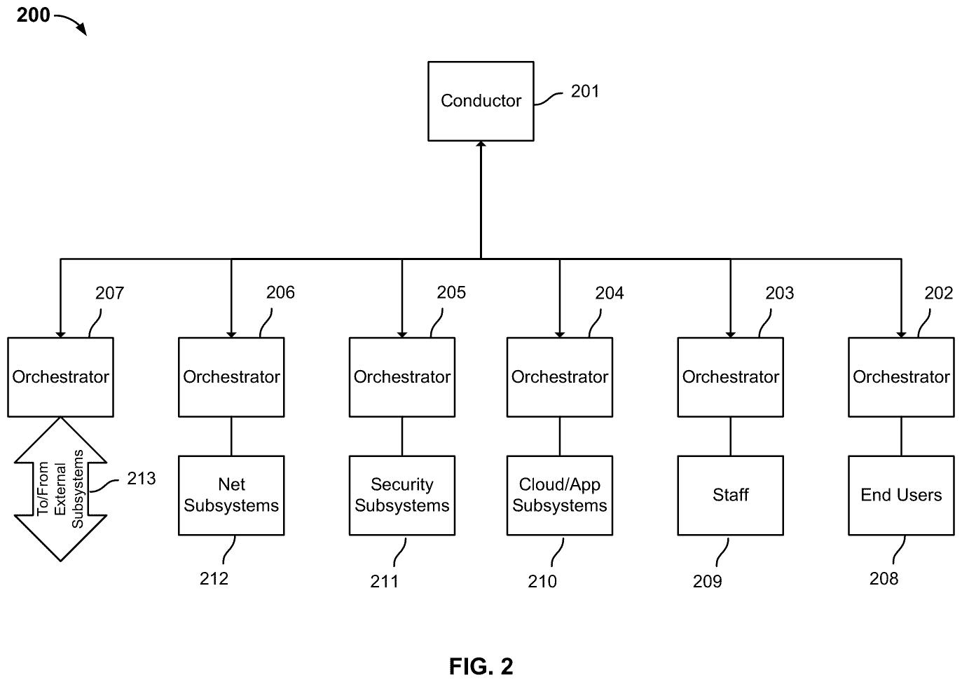

FIG. 2 illustrates a high-level example of a deterministic mechanism for mitigating AI negative side effects in accordance with some embodiments.

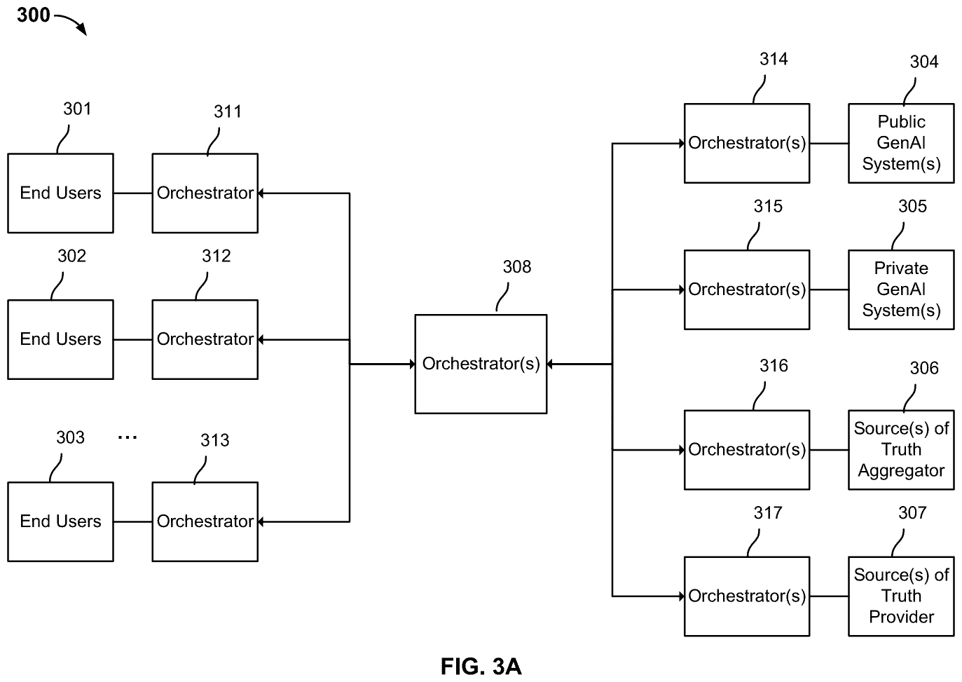

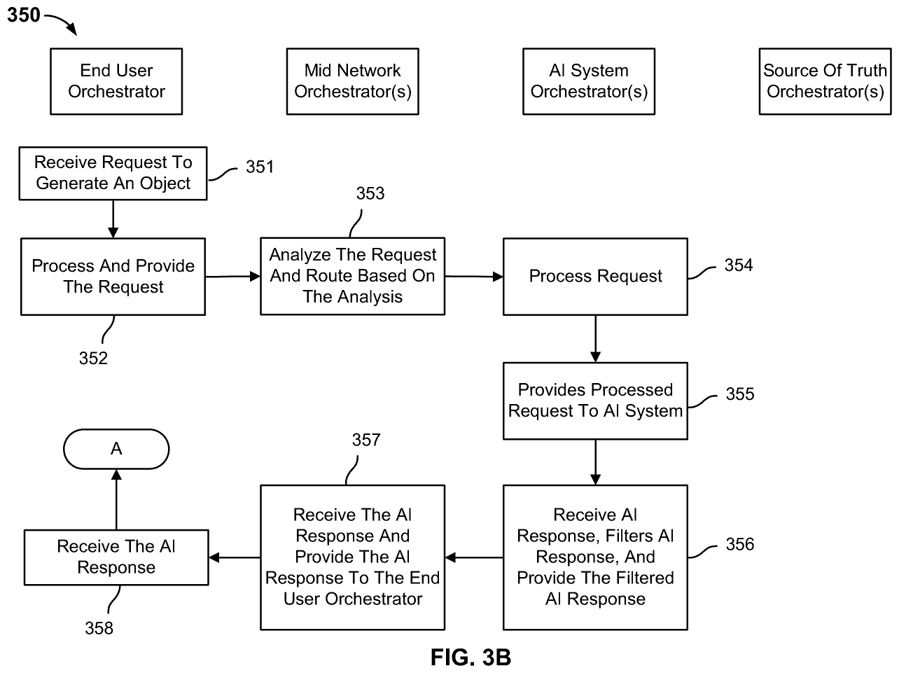

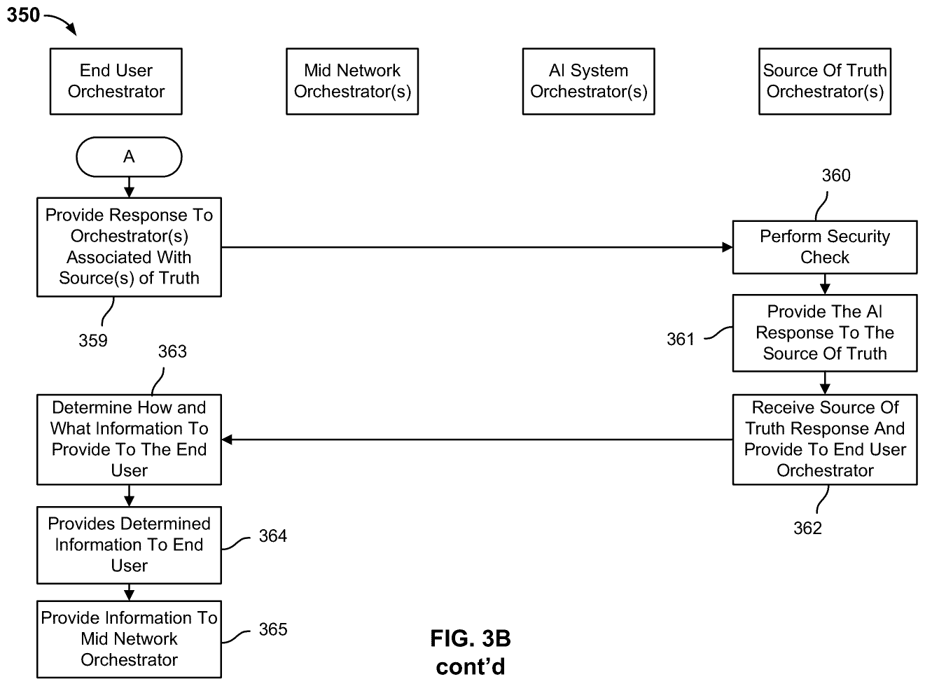

FIG. 3A is an example of a system that includes a plurality of distributed orchestrators in accordance with some embodiments.

FIG. 3B is a flow diagram illustrating a process of mitigating negative side effects associated with AI in accordance with some embodiments.

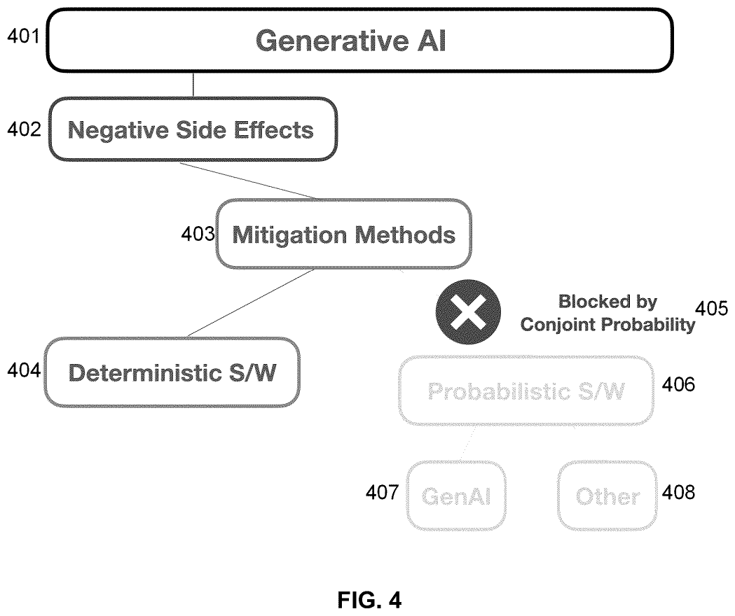

FIG. 4 provides a graphical representation of how conjoint probability blocks the use of such probabilistic solutions.

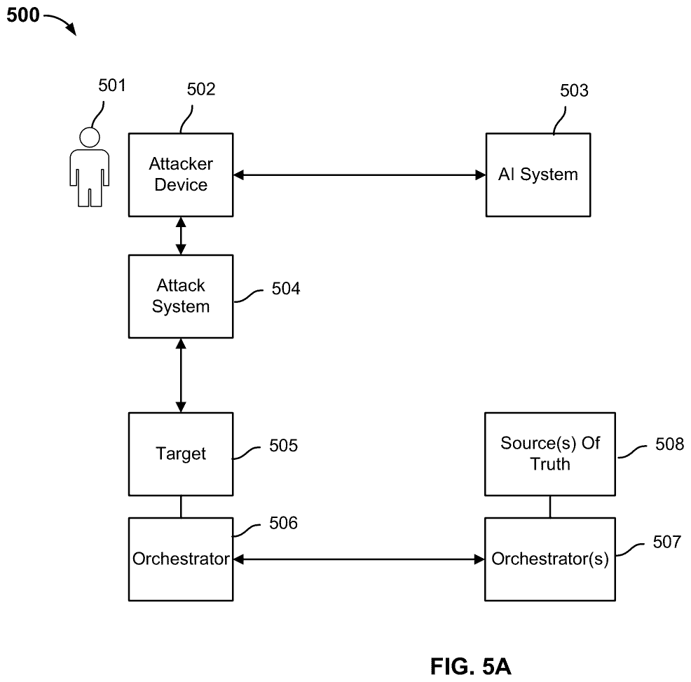

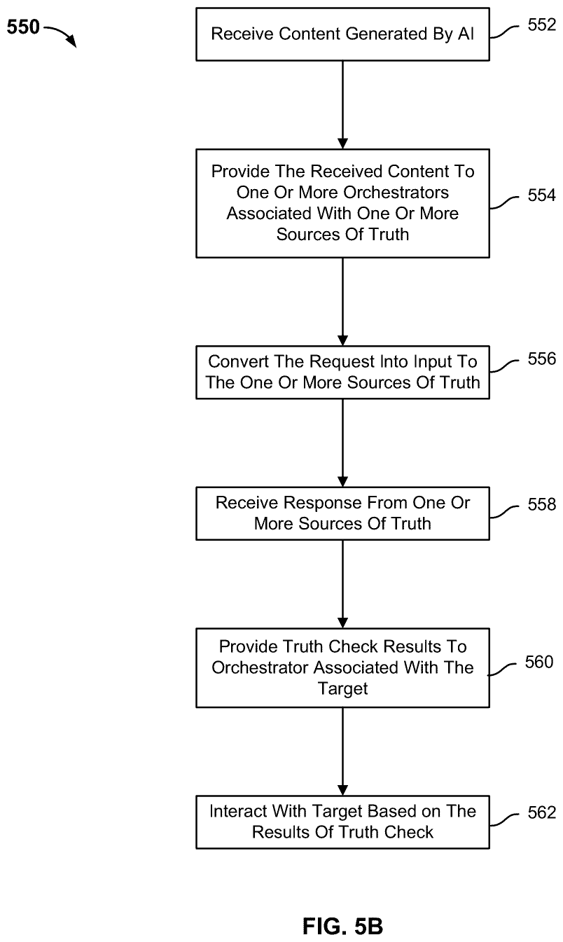

FIG. 5A is a block diagram illustrating a system to mitigate against social engineering attacks in accordance with some embodiments.

FIG. 5B is a block diagram illustrating a process to mitigate against social engineering attacks in accordance with some embodiments.

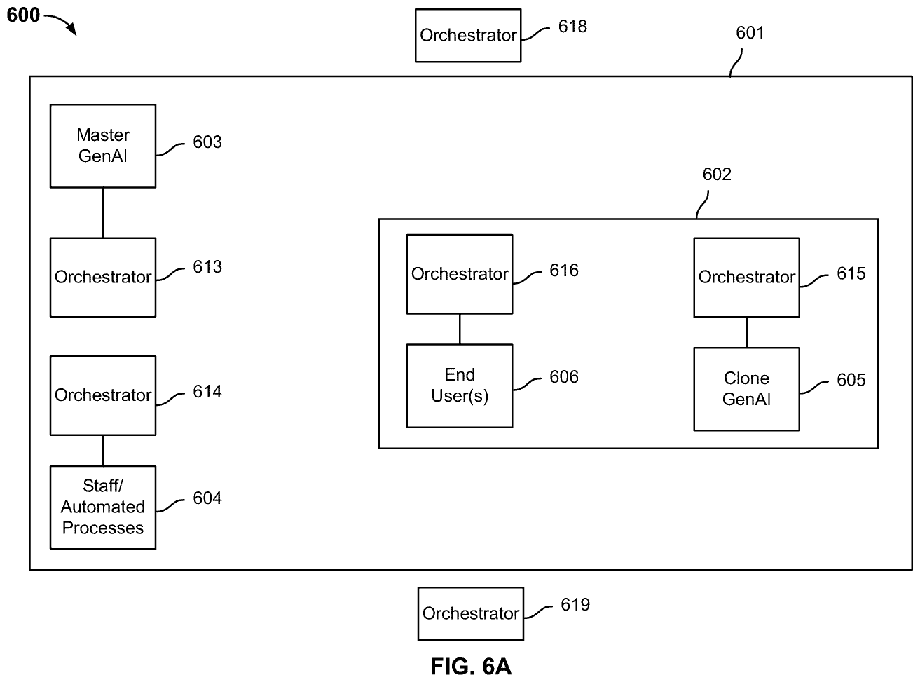

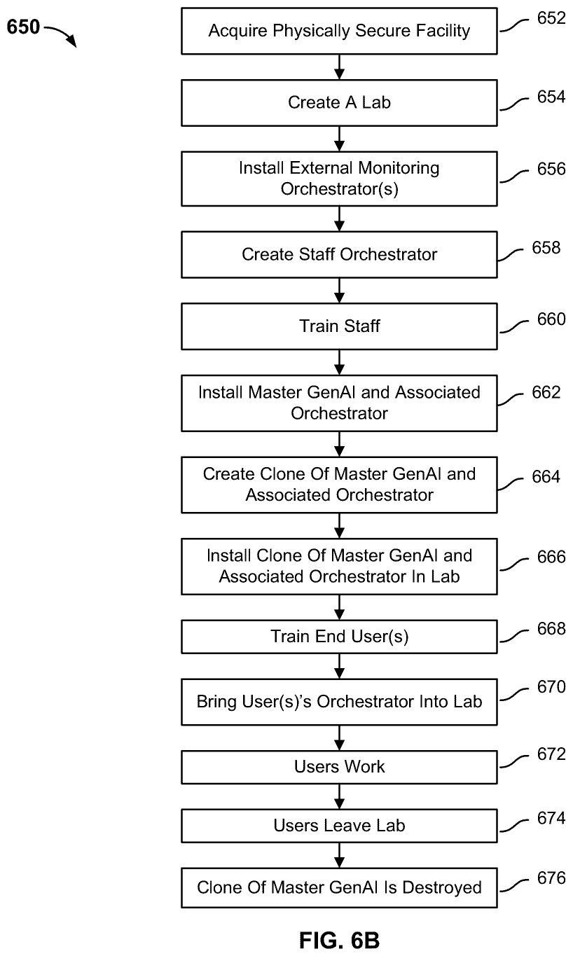

FIG. 6A is a block diagram illustrating a system to physically secure an AI system in accordance with some embodiments.

FIG. 6B is a flow diagram illustrating a process to physically encapsulate an AI system in accordance with some embodiments.

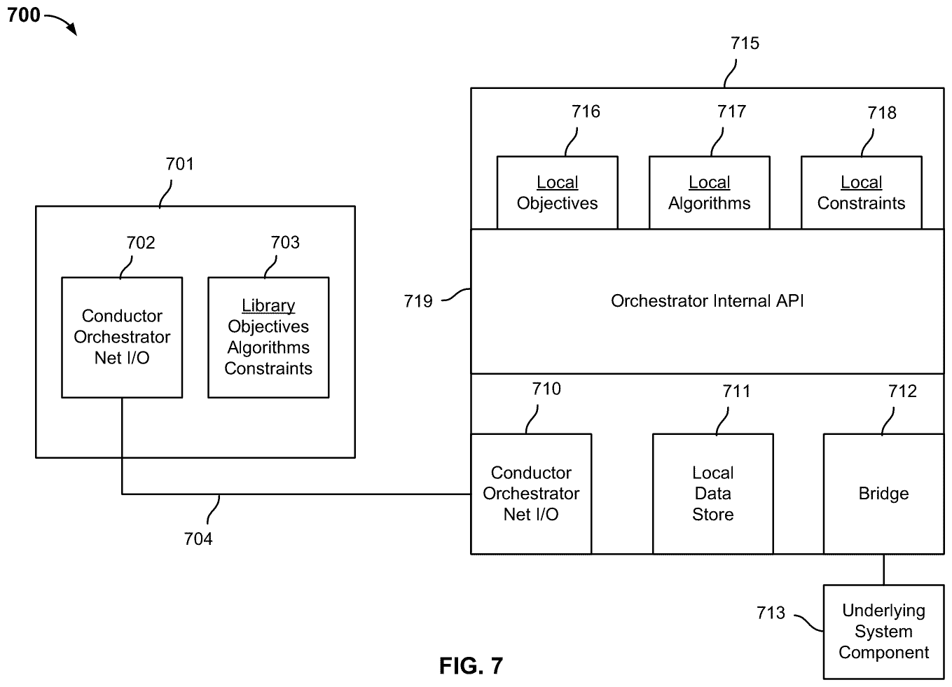

FIG. 7 is a block diagram illustrating a system to encapsulate software in accordance with some embodiments.

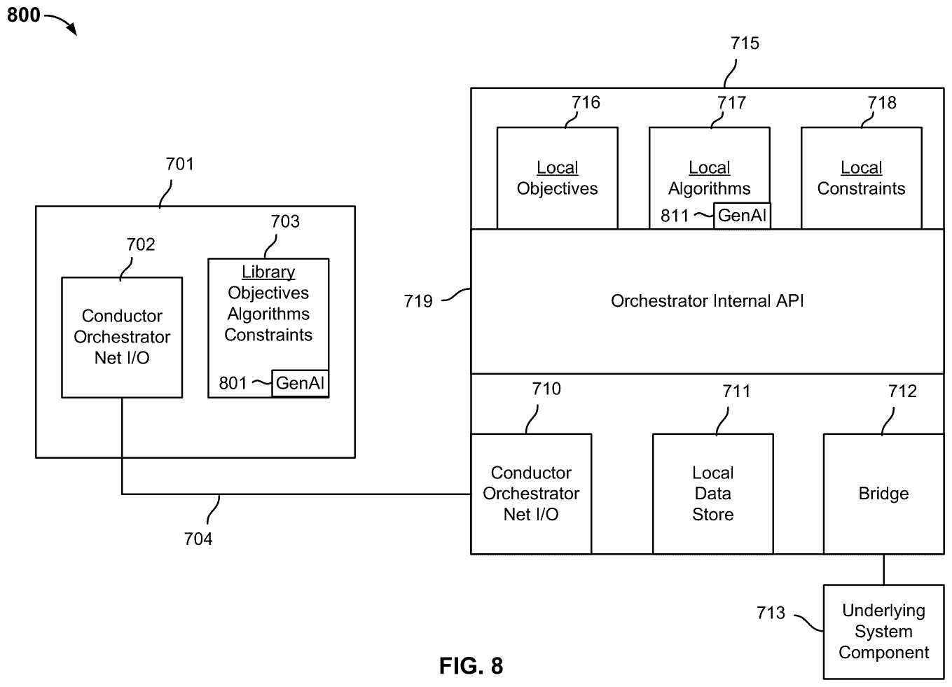

FIG. 8 is a block diagram illustrating a system to encapsulate software in accordance with some embodiments.

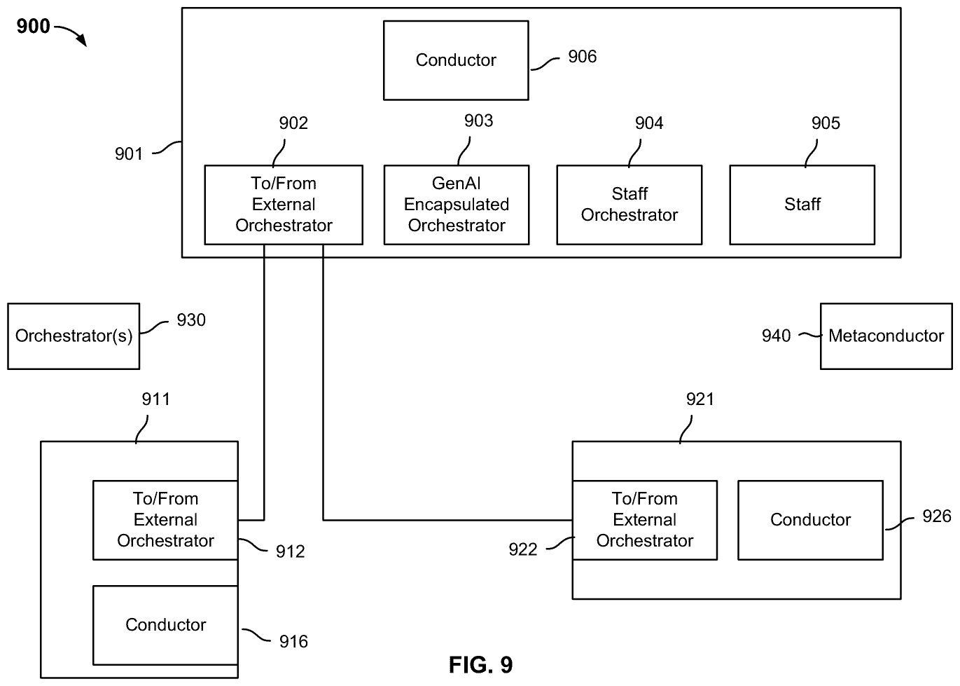

FIG. 9 is a block diagram illustrating a system that includes three simplified versions of inter-related environments in accordance with some embodiments.

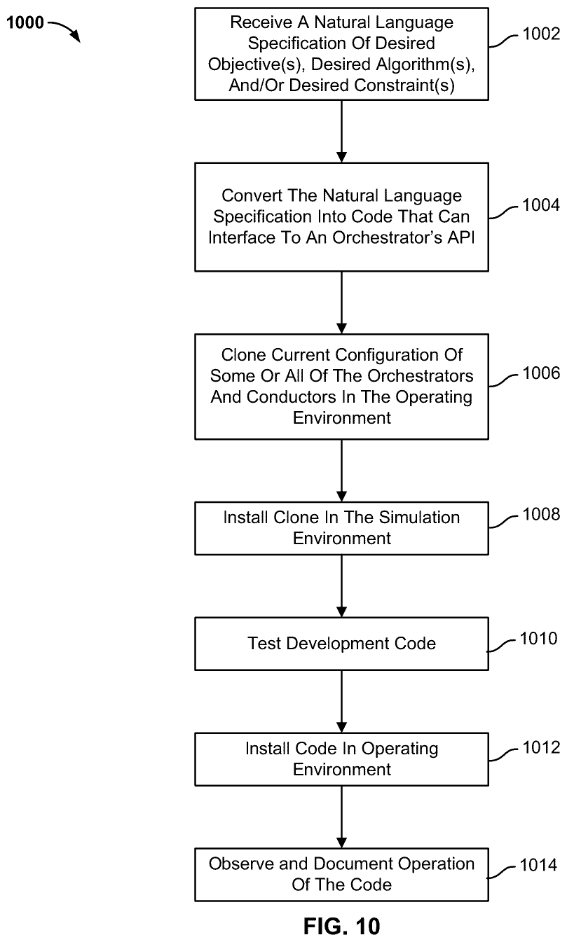

FIG. 10 is a flow diagram illustrating a process to test and develop code in accordance with some embodiments.

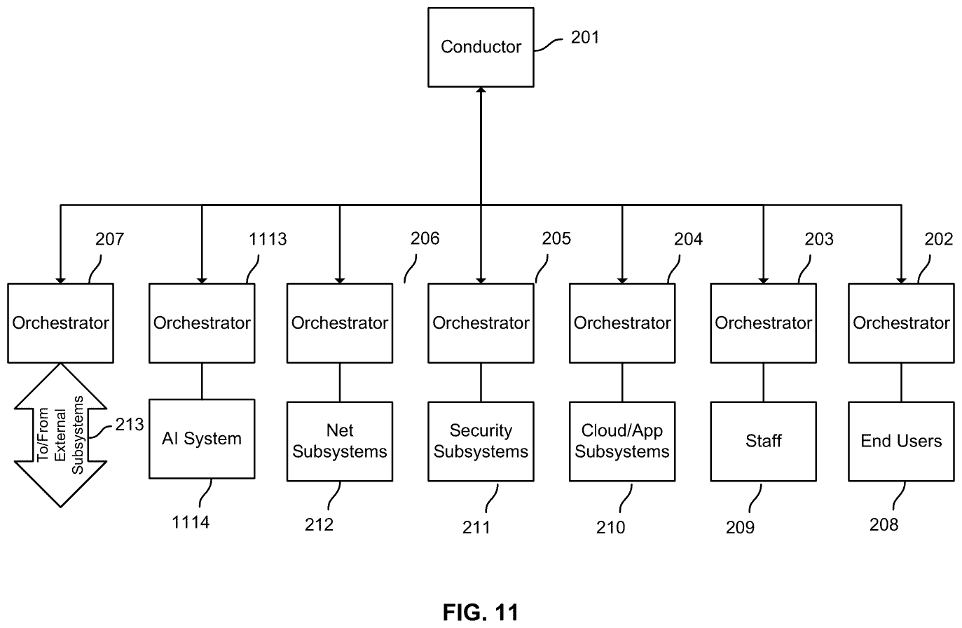

FIG. 11 is a block diagram of a system to perform software encapsulation in accordance with some embodiments.

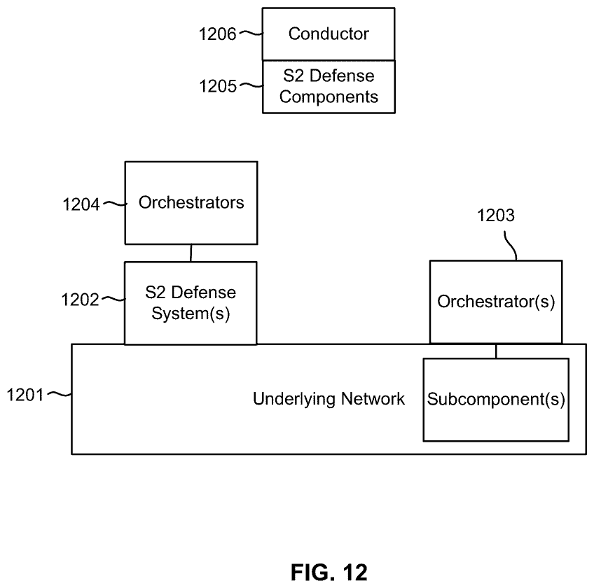

FIG. 12 is a block diagram of a system to defend AI cyber attacks in accordance with some embodiments.

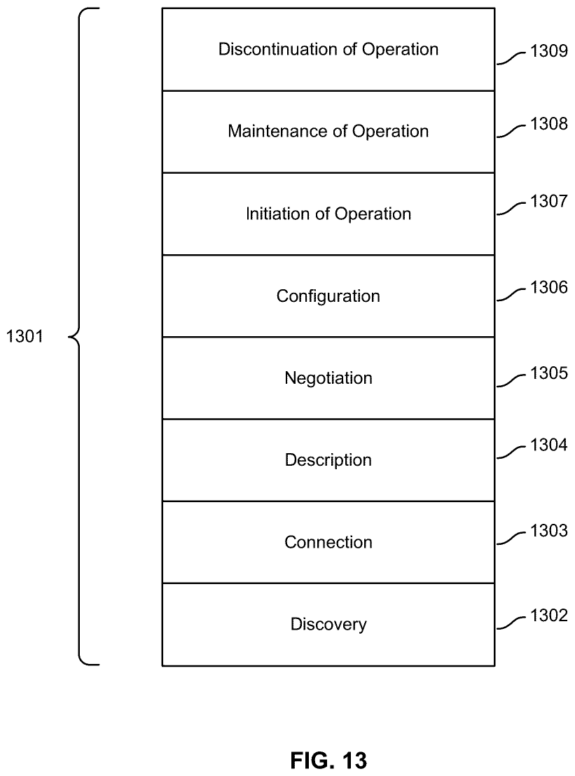

FIG. 13 provides a high level description of the overall negotiation, cooperation, and coordination mechanism in accordance with some embodiments.

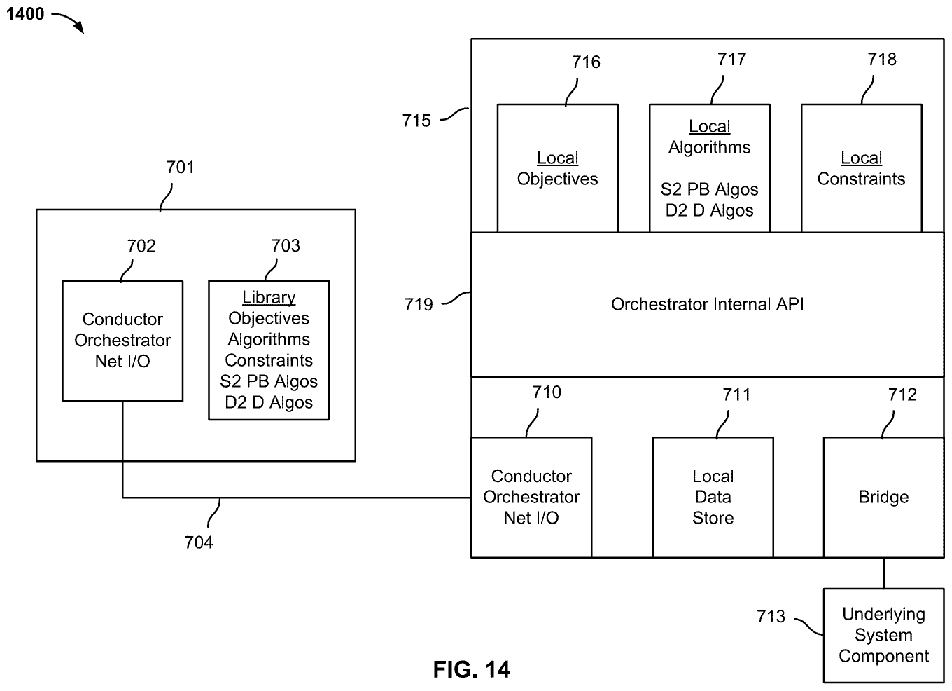

FIG. 14 is a block diagram illustrating a system to encapsulate software in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods for increasing the benefits while mitigating negative side effects in emerging technologies, such as AI, are disclosed. As these emerging technologies evolve, the terminology may also evolve and new terms may be used to describe what is currently known as AI. Nevertheless, the systems and methods disclosed herein describe a set of mechanisms that mitigate today's and tomorrow's AI (and whatever new term is created) negative side effects while acting to increase AI positive benefits. The set of mechanisms may be performed by an orchestrator-conductor network, built into one or more AI applications, built into one or more other applications, built into one or more operating systems, etc.

The negative side effect problem is discussed herein in various example domains. Although a problem may be highlighted in one domain, in most cases, the problem appears in many other domains as well. In some cases, the problems are highlighted with real world experiences. Although these experiences may only be documented in one domain, they often affect other domains, or all domains. Also, although the problems are discussed separately from the unique innovative solutions, they are inextricably intertwined.

### AI Negative Side Effects Overview

A taxonomy of negative side effects is shown in FIG. 1. There are likely to be more negative side effects that have not been documented yet. Plus, more are likely to emerge. To differentiate between positive and negative effects, financial gain/loss and quality of life (QoL) factors are used.

Taxonomy element 101 is the general set of emerging AI tools. These tools have negative side effects 102 and benefits 103. Since the positive effects are what is desired, the negative effects are characterized as side effects. The types of negative side effects include, but are not limited to, hallucinations 104, cybersecurity effects 105, and IP (Intellectual Property) Leakage 118.

Cybersecurity is the protection of the unauthorized use of communications and computing resources. Hallucinations is a term that is emerging in common usage for the range of negative side effects that involve AI producing what looks like convincing output that is false or unreal.

Hallucination negative side effects include a first type of hallucination that results in corrupted information 106 and a second type of hallucination results in AI generating damaging actions and/or damaging manipulation 107. Corrupted information 106 may include two sub categories of hallucination: documents 110 or audio/video 111. Examples of corrupted information documentation examples include, but are not limited to: citing nonexistent cases in legal briefs, falsely attributing information that negatively affects reputations, etc. Examples of corrupted information audio/video AI information hallucinations examples include, but are not limited to: audio and video purported to be of real events that never existed, insertion of pornographic material in advertising, etc. These can impact government, military, political, enterprise, business, educational, social, and/or other types of domains.

The second type of hallucination, damaging actions and/or manipulation 107, includes two sub categories: damage to people 112 and/or things 113. Examples concerning damaging actions negatively affecting people include, but are not limited to, medical systems such as medical AI diagnostic, lab test, treatment, etc. systems. Examples concerning damaging actions negatively affecting both people and things include, but are not limited to, military systems killing the wrong person, designating wrong targets, etc. Similar examples exist for police, diplomatic, etc. systems and a broad range of infrastructure control systems.

Intellectual property leakage 118 may include concerns when proprietary information is input into an AI system as part of a request to that AI system, that proprietary data will be used for training the AI system and as a result may leak out to other end users, be used by the AI system itself for purposes contrary to its owner's interest, get caught up in a hallucination, etc. There is also a danger that programing code requests and/or the resulting code can be used by the AI system to support cyber attacks. Similarly, there is a danger that using AI systems to test systems in general and/or cybersecurity aspects of systems in particular may act to train the AI system to be a better attacker.

Cybersecurity negative side effects can result in infrastructure and/or application corruption 108 and/or social engineering 109. Infrastructure and/or application corruption can be done on behalf of one or more bad actors 114, and/or on behalf of the AI system itself 115. Similarly, social engineering 109 can be done on behalf of one or more bad actor(s) 116 and/or on behalf of the AI system itself 117.

### AI Negative Side Effects Mitigation Mechanisms Overview

### Conjoint Probability Problems

Some have suggested using AI to protect against AI created negative side effects. However, conjoint probability informs us that using one probabilistic system whose probabilistic nature is the cause of negative side effects to control another such system will make things worse, not make things better. For example, using an AI system to mitigate another AI system's hallucinations is unlikely to make things better. The first AI system will also hallucinate causing false positives, false negatives, and other unpredictable strange outcomes. The range of probability of hallucination depending on the system and the complexity of tasks ranges from 3% to 88%, indicating the seriousness of the problem.

FIG. 4 provides a graphical representation of how conjoint probability blocks the use of such probabilistic solutions. 401 is the class of AI systems. 402 are the negative effects. 403 are the mitigation methods. Mitigation methods include the use of deterministic software systems 404 and the use of probabilistic software systems 406. The use 405 of probabilistic software systems 406 is blocked by conjoint probability problems mentioned above. 407 is the class of AI systems being used to attempt to mitigate negative side effects. 408 is the use of other probabilistic methods to mitigate AI negative side effects.

### Deterministic Mechanisms Avoid Conjoint Probability Problems

Deterministic mechanisms are disclosed here for mitigating AI negative side effects. Using deterministic mechanisms avoids the conjoint probability problems. A deterministic system is a system in which no randomness is involved in the development of future states of the system.

FIG. 2 illustrates a high-level example of a deterministic mechanism for mitigating AI negative side effects in accordance with some embodiments. In the example shown, the conductor 201 is responsible for creating and managing the configuration of the orchestrators 202-207. Both the conductor and the orchestrators are deterministic systems. Each orchestrator 202-207 is associated with a subsystem of the underlying networking, computing, storage, AI, etc. system. Orchestrator 202 is associated with end user(s) 207 (End users are people and/or machines that initiate actions, consume responses, etc. Orchestrator 202 tracks the behavior of, interacts with, etc. the end user(s) it is associated with. That end user may access system resources via a number of devices. In some embodiments, the end user uses a specific device(s) and orchestrator(s) 202 is also associated with that device(s) to track the behavior of, interact with, etc. the end user(s)), orchestrator 203 is associated with staff 209 (Staff are people that initiate actions, consume responses, etc. orchestrator 203 tracks the behavior of, interacts with, etc. the staff member(s) it is associated with. That staff member(s) may access system resources via a number of devices. In some cases that staff member uses a specific device(s) and orchestrator(s) 203 is also associated with that device(s) to track the behavior of, interact with, etc. the end user(s)), orchestrator 204 is associated with cloud/app subsystems 210, orchestrator 205 is associated with security subsystems 211, orchestrator 206 is associated with net subsystems 212, and orchestrator 207 is associated with components 213 external to the underlying system and/or, in some cases, not within the span of control of the conductor 201. The conductor 201 and orchestrators 202-207 communicate in an overlay network. The resulting system 200 has the following characteristics/capabilities, including but not limited to the use of an umbrella information model that acts as a lingua franca and is translated at each point of contact with the underlying network's component/sub system (such as 210) into that component's local data model, the ability to deliver just the data needed when/where needed, a negotiation/cooperation/coordination process, the sensing and actuation abilities, dynamic behavior tracking, dynamic problem identification (both operational problems and cybersecurity attacks), dynamic remediation of problems, etc. Conductor 201 is configured to provision one or more orchestrators, set-up the one or more orchestrators, configure the one or more orchestrators, manage the one or more orchestrators, and retire the one or more orchestrators. In some embodiments, conductor 201 is configured to perform all of the functions of orchestrators 202-207.

Orchestrators and conductors share an umbrella data model that is a superset of the local data models and acts as a lingua franca. An orchestrator or a conductor uses an internal component called a bridge to translate to/from the umbrella model and the local data model of the subsystem with which it is associated. The umbrella model can be updated in real time without interrupting the operation of the orchestrator(s)/conductor(s). The orchestrator(s)/conductor(s) operate based on objectives, algorithms, and constraints specified by the owner and/or operators of the overlay network. Objectives can be thought of as descriptions of desired outcomes. Algorithms can be ways of achieving desired outcomes, and/or ways of measuring desired outcomes, and/or ways of measuring parameters, and/or ways of combining parameters to make a determination, and/or ways of conductors/orchestrators cooperating/coordinating/synchronizing with each other, etc. Constraints are descriptions of boundary conditions that are not to be violated. An example for a conductor is deciding how many orchestrators to deploy in a system to protect against dynamic AI generated attacks. The owner/operator of the system will specify objectives such as minimize damage from cyber attacks and minimize the number of orchestrators. The algorithm to balance these two objectives may be to use the time required to ID and remediate attacks. The constraints may be: never have fewer than X orchestrators, never have more than Y orchestrator's, never allow attack ID time to exceed A, never allow attack remediation time to exceed B. etc. An example for an orchestrator is an objective of identify a typical behavior and determine if it is a result of normal operations or indicates a cyber attack/operational problem. The algorithm is based on using a moving sum average of a histogram of all available parameters from the underlying sub system the orchestrator is associated with and applying statistical mathematical methods to determine if a deviation from the average is significant.

A histogram is a list of parameters and their frequency (number of occurrences) in a given period of time. For example, a histogram may be generated for a data element and track the values of the data element and the number of times each value was generated. An automated process that observes all of the available data sources may be implemented to determine the proper timing of samples for creation of histograms. A statistical algorithm is used to automatically determine the valid sample size for each implementation. The frequency of activity is observed and used to automatically calculate the minimum time segment required to produce a statistically valid sample. Then, histogram(s) may be created for that sample period. For example, a sample period may correspond to every second, every minute, every 10 minutes, every half hour, every hour, every 6 hours, every 12 hours, every day, every other day, etc. Sample periods are tracked and automatically updated if necessary.

The histograms are constructed without regard to “meaning”, nor manually created search patterns (whether or not augmented by automated processes). They are merely counts. A moving sum statistically valid average histogram is constructed from the first and succeeding histograms. The number of histograms needed for this moving sum average is automatically determined by a statistical algorithm. Newly created histograms are compared to this moving sum average as they are created. Any change of more than a threshold amount (e.g., given percentage, a given amount) then the moving sum average may generate an alert. This percentage may be automatically set by a statistical algorithm for each implementation. In most types of attack a significant change of behavior will occur. Once the orchestrators are widely deployed throughout a system, it is possible that attackers will vary their attacks and seek to trickle their activity so that it doesn't reach the trigger percentage. To guard against this, an automated process may specifically and automatically search for trickle patterns in the histograms separate from the moving sum averages. Based on inputs from orchestrators associated with threat intelligence systems, the orchestrator building and tracking histograms may use its objectives, algorithms, and constraints to trigger alerts based on specific patterns in the histograms and their changes.

The histogram behavioral analysis algorithm may be performed in an orchestrator, a conductor, or a collector. The histogram behavior analysis algorithm may be performed by any combination of one or more orchestrators, one or more conductors, and/or one or more collectors. The orchestrators or collectors can get data to work with by connecting to existing interfaces. These interfaces may generate streams of information in their normal operation that the orchestrators or collectors can “tap,” that is, listen to in a non-disruptive fashion. Other interfaces may only respond to requests sometimes called “polls”.

In some embodiments, the histogram behavioral analysis algorithm is performed in a distributed process. This allows the amount of data that has to be dealt with at each behavior analysis engine to be greatly reduced. Furthermore, the histogram behavioral analysis algorithm does not require keeping the underlying data. Once a histogram has been created for a sample data set, that data set can be discarded. Thus, an orchestrator employing the histogram behavioral analysis algorithm does not need to store the full data sets from which it is counting parameters. This is in contrast to behavioral analysis systems that must keep multiple such full data sets covering days, weeks, months, etc. In contrast, the histogram behavioral analysis algorithm described here may only need to keep the small moving sum average histogram data set and the currently being assembled histogram data set. By distributing the capture and analysis of the input data, the volume of data, even when all sources are employed, that each behavioral analysis engine has to deal with is limited to a manageable level. This distributed system with its data volume advantages may be used in conjunction with traditional existing types of behavioral analysis systems (e.g., classical behavioral systems, approximate query behavioral analysis systems, etc.) or with combinations of the moving sum average histogram and the existing ones mentioned above. Central site behavior analysis systems can still be used to employ the moving sum average algorithm by themselves or in combination with some or all of the alternatives mentioned above.

In one embodiment, a constraint associated with a histogram behavioral analysis algorithm is not to consider any deviation that is smaller than one Sigma.

In some embodiments, a first orchestrator and one or more other orchestrators use their corresponding objectives, algorithms, and constraints to negotiate, cooperate, and/or coordinate with each other to identify situation characteristics and appropriate responses to those situations. In some embodiments, an orchestrator and a conductor use their corresponding objectives, algorithms, and constraints to negotiate, cooperate, and/or coordinate with each other to identify situation characteristics and appropriate responses to those situations. In some embodiments, a first conductor and one or more other conductors use their corresponding objectives, algorithms, and constraints to negotiate, cooperate, and/or coordinate with each other to identify situation characteristics and appropriate responses to those situations.

Cooperation between orchestrators can be by direct request, mutual agreement to use a certain algorithm and be bound by the result of the algorithm, auction of resources, staff requests, and/or inputs mediated by the staff orchestrator, etc. In some embodiments, mutual decisions are made through an iterative bid and bind process. That is, one orchestrator or conductor makes a suggestion (bid) to an other orchestrator(s) or conductor(s). The other(s) either accept the offer (bind) or make another suggestion (bid). This continues until all parties agree (bind) to a specific suggestion. The bid and bind process may be used just to maintain synchronization, to make joint decisions, to arrive at a compromise solution where objectives between different orchestrators diverge, etc. For example, in some embodiments, based on defending against the AI launched cyber attack use case discussed above, orchestrator A detects a behavioral anomaly that indicates that the sub system with which orchestrator B is associated is experiencing a cyber attack. Orchestrator A's set of objectives includes an objective to prevent sub systems (the one with which it is associated and others) from corrupting the overall system. Based on this objective, it bids that orchestrators A and B together prevent any communication into or out of the sub system with which orchestrator B is associated. Orchestrator B has two objectives: 1.) prevent sub systems (the one it is associated with and others) from corrupting the overall system; and 2.) maintain B's quality of service as high as possible. Based on these two objectives, orchestrator B sends a bid back to orchestrator A suggesting that the attack and associated leakage of information is coming from and going to only one IP address and therefore suggests that only communication to or from that IP address be stopped. Orchestrator A agrees and sends a bind to orchestrator B. Orchestrator B sends a bid to orchestrator C that is associated with the firewall that controls access to/from orchestrator B's sub system suggesting orchestrator C cause it's sub system (the firewall) to add the IP address to the firewall's black list and thus block communication to from it. Orchestrators A and C send a bind to orchestrator B. Orchestrator C causes the firewall to add the IP address to the black list.

In some embodiments, orchestrator-orchestrator communication and cooperation is implemented utilizing the negotiation, cooperation, and coordination mechanism shown in FIG. 13. In some embodiments, orchestrator-conductor communication and cooperation is implemented utilizing the negotiation, cooperation, and coordination mechanism shown in FIG. 13. In some embodiments, conductor-conductor communication and cooperation is implemented utilizing the negotiation, cooperation, and coordination mechanism shown in FIG. 13.

FIG. 13 provides a high level description of the overall negotiation, cooperation, and coordination mechanism in accordance with some embodiments. The overall negotiation, cooperation, and coordination mechanism 1301 includes a plurality of components. The mechanism 1301 can be thought of as a flow chart from bottom to top, and/or as group of interrelated mechanisms, and/or as a protocol, etc.

The first part of mechanism 1301 is the discovery portion 1302. Discovery can be the recognition of a new element that must be communicated with, and/or the occurrence of an event that requires communication, cooperation, coordination, etc. For example, an orchestrator associated with element A (OA) in the underlying network could discover that an orchestrator associated with element B (OB) in the underlying network has appeared; and/or element A's orchestrator could already in communication with element B's orchestrator and discover that a parameter change in an element in the underlying network necessitated communication with element B's orchestrator, etc.

The second part of mechanism 1301 is the establishment of a connection 1303 between two orchestrators, between an orchestrator and a conductor, or between two conductors. For example, the orchestrator associated with element A establishes a connection with the orchestrator associated with element B.

The third part of mechanism 1301 is the exchange of descriptions 1304 between two orchestrators, an orchestrator and a conductor, or between two conductors. For example, if element A's orchestrator has discovered the just appeared element B, each provides the other with a description of themselves; and/or if an underlying parameter change has been discovered, a description of it; etc. For example, in one embodiment, OA discovers that element B with OB has appeared in the network. OA requests that OB (or a conductor) provide a description of B in terms of the umbrella data model. Such a description traces the root/tree/branch taxonomy of sub systems in the umbrella model to define the type of sub system. Then provides key parameter information unique to that particular instance of that type.

The fourth part of mechanism 1301 is negotiation 1305 between two orchestrators, an orchestrator and a conductor, or between two conductors. For example, an orchestrator may discover a new orchestrator. Negotiation 1305 is utilized to determine how the two orchestrators will communicate with each other. A parameter may change. Negotiation 1305 is utilized to enable the two orchestrators to respond to the parameter change. For example, in one embodiment, using the same use case as described above, the two orchestrators negotiate with each other using their corresponding objectives, algorithms, and constraints and arrive at the bind described above for that use case.

The fifth part of mechanism 1301 is configuration 1306 of the two orchestrators, an orchestrator and a conductor, or two conductors. For example, in one embodiment, in the same use case described above, OB may indicate that local law requires that a notice be sent to the IP address T time before communication is cut off and therefore it has a constraint. OB therefore sends a bid requesting synchronization. OA and an orchestrator associated with element C (OC) respond with bind messages.

The sixth part of mechanism 1301 is the initiation of operation 1307 of the pre-staged change(s)/preservations(s). Configuration and initiation are separated mechanisms because of the possibility of need to synchronize the initiation with each other; with specific events including but not limited to changes in parameters in the: underlying network, the conductor/orchestrator network, etc.; etc. For example, in one embodiment, using the same use case described above, OB sends an initiation message when the required notification message has been sent. OC starts a timer and when time T arrives, updates the blacklist. There may be other sub systems and associated orchestrators involved in sending and confirming that the message has been sent.

The seventh part of mechanism 1301 is the maintenance of operation 1308 in the mode initiated. For example, that mode is there in case of future changes in parameters with future adjustments in configurations, etc. For example, in one embodiment using the same use case described above, the attacker may change the IP address they are using. In maintenance mode, OB and OC would issue bid and bind messages to further update the blacklist with the new IP address. However, just adding IP addresses to the IP list might end up making the firewall's blacklist so long that it would substantially degrade performance. In maintenance mode, OC would track the length of the blacklist. OC has a constraint not to let the IP list exceed a length L and an algorithm that when the blacklist reaches ½L to start checking each entry to see if it can be removed. In doing so, OC would send a bid to OB requesting the removal of IP address number one. If the attacker no longer used IP address number one, OB would send a bind to OC. OC would delete address number one from the blacklist.

The eighth part of mechanism 1301 is the discontinuation of operation 1309 in the mode initiated. For example, that mode may have anticipated future changes in parameters that would trigger discontinuation of the operation, etc. For example, in one embodiment using the same use case described above, OB may have an algorithm that says when there has been no attack symptom detected for time T1, mark the attack as over. When OB detects that T1 has occurred, it sends a bid to OC. OC responds to OB with a bind. OC then removes all remaining IP addresses provided by OB.

Each orchestrator monitors the behavior of a subsystem with which it is associated. The granularity of the subsystems can be as fine or as course as best suits the type of hallucination, security threat, operational problem, needs of the network owner/operator, needs of the operating staff, needs of the end users, etc. being addressed. Orchestrators and conductors can be moved around in the network without being reprogramed, retrained, etc. In some embodiments, both conductors and/or orchestrators are associated with subsystems that themselves can be moved—for example, but not limited to, in a Cloud computing environment. In some embodiments, an orchestrator or conductor is moved (cloned and copied) from a development environment to a simulation environment. In some embodiments, an orchestrator or conductor is moved (cloned and copied) from a simulation environment to a development environment. In some embodiments, an orchestrator or conductor is moved (cloned and copied) from a development environment to an operating environment. In some embodiments, an orchestrator or conductor is moved (cloned and copied) from an operating environment to a development environment. In some embodiments, an orchestrator or conductor is moved (cloned and copied) from a simulation environment to an operating environment. In some embodiments, an orchestrator or conductor is moved (cloned and copied) from an operating environment to a simulation environment. In some embodiments, an orchestrator or conductor is moved between data centers, mid network, to a network edge, etc. The orchestrator or conductor may be moved based on one or more policies, such as security, reliability, and/or performance reasons that keep the orchestrator/conductor close to a component, but on a separate hardware/communication system, or someplace else in the network. The closer an orchestrator is to the component with which it is associated, the better the performance of the orchestrator due to lower latency, access to more and fresher data, etc. This is because data has not been summarized and delayed to lessen load on the network, etc.

### AI Hallucinations

Hallucination is a term that has come into common usage as a label for a particular set of AI negative side effects. As a term, it is not exactly accurate. However, it gives a general sense of meaning that can be helpful. In humans, hallucinations are perceptions of sensory data (images, sounds, tastes, smells, etc.) that do not actually exist. Despite the fact that they don't exist, the person having the hallucination experiences something that appears to be actual perception. For simplicity sake, let us call this “high fidelity”. This high fidelity is what is similar with AI hallucinations.

AI hallucinations create outputs that are undesired in that they have false information, contain instructions to do counterproductive actions, etc. When these are created, they too have a very high fidelity. So high that they can be very convincing. Thus, these AI hallucination created outputs are easy to rely on. It is this property that has led to these kinds of outputs being called hallucinations. Another similar aspect of AI hallucinations is that when an AI system is confronted with a hallucination, the AI system has been observed continuing to maintain that it is true.

Hallucinations are a very important and widespread problem. Recent measurements show that for simple hallucinations depending on the particular public AI systems deployed, the range of occurrence of hallucinations ranges from 3% to 27% and may be even higher. For complex questions in an area such as law, and/or medicine, hallucination rates range from 69% to 88%.

### Mitigating AI Hallucinations

To eliminate AI hallucinations, mechanisms are disclosed using deterministic systems connected to a particular type of existing system often referred to as a “source of truth system.” The deterministic nature of these systems is very important. It appears that the probabilistic nature of AI systems is involved in their creation of hallucinations. Therefore, combining another probabilistic system to try to control aberrations from a first probabilistic system is, because of conjoint probability, likely to make things worse, not better.

Source of truth systems may contain information collected from machine, human, or combinations of the two sources. There may be source of truth systems that include manual response as part of their process. Direct manual response may be subject to problems with subjective information. Statistical and tracking history techniques can be used to help verify human responses. Source of truth systems work best when they can deliver objective data. At the same time, latency allowing, there is a desire to keep humans in the loop. This balancing act is very important and the mechanisms disclosed herein are particularly well suited to maintaining such a proper balance.

FIG. 3A is an example of a system that includes a plurality of distributed orchestrators in accordance with some embodiments. In some embodiments, system 300 is implemented to mitigate AI hallucinations. In FIG. 3A, an end user may use a specific dedicated machine to gain access, and/or multiple machines. An end user may enter the system through one specific portal and/or may access the system from a number of portals. The machine the end user uses to access the system may or may not have an orchestrator(s) associated with it. If an end user has an associated orchestrator(s), those orchestrators keep track of the activity of that end user and/or deliver suggestions, instructions, information, etc. to the end user. The orchestrator(s) that are associated with specific end users may be in close proximity to the end user, and/or someplace else in the network.

An end user machine, system, or portal (referred to as “end user” herein) is associated with a corresponding orchestrator. Although FIG. 3A depicts three end users and three corresponding orchestrators, system 300 may include 1:n end users associated with 1:n orchestrators, respectively. End user 301 is associated with orchestrator 311, end user 302 is associated with orchestrator 312, and end user 313 is associated with orchestrator 313.

Orchestrators 311, 312, 313 are configured to communicate with one or more orchestrators 308, which is a mid-network orchestrator. The one or more orchestrators 308 are configured to communicate with orchestrators 314, 315, 316, 317. One or more orchestrators 314 are associated with one or more public generative AI systems 304. In some embodiments, an orchestrator 314 is associated with a single public generative AI system 304. In some embodiments, an orchestrator 314 is associated with a plurality of public generative AI systems 304. In some embodiments, a plurality of orchestrators 314 are associated with one or more corresponding public generative AI systems 304.

One or more orchestrators 315 is associated with one or more private generative AI systems 305. In some embodiments, an orchestrator 315 is associated with a single private generative AI system 305. In some embodiments, an orchestrator 315 is associated with a plurality of private generative AI systems 305. In some embodiments, a plurality of orchestrators 315 are associated with one or more corresponding private generative AI systems 305.

In some embodiments, one or more orchestrators 315 is associated with one or more hybrid generative AI systems (a combination of public and private generate AI system).

One or more orchestrators 316 is associated with one or more sources of truth aggregator 306. In some embodiments, an orchestrator 316 is associated with a single source of truth aggregator 306. In some embodiments, an orchestrator 316 is associated with a plurality of sources of truth aggregator 306. In some embodiments, a plurality of orchestrators 316 are associated with one or more corresponding sources of truth aggregator 306.

One or more orchestrators 317 is associated with one or more sources of truth provider 307. In some embodiments, an orchestrator 317 is associated with a single source of truth provider 307. In some embodiments, an orchestrator 317 is associated with a plurality of sources of truth provider 307. In some embodiments, a plurality of orchestrators 317 are associated with one or more corresponding sources of truth provider 307.

The actual source of truth can vary even within a domain. The actual source of truth may be a truth aggregator or a truth provider. For example, in the legal profession, LexisNexis is one of many truth aggregators. LexisNexis aggregates data it gets from a truth provider, such as underlying courts' record-keeping systems as well as other verified legal documentation. Thus, those underlying systems can also be used as a source of truth.

In some embodiments, a source of truth system, such as source of truth aggregator 306 or a source of truth provider 307, is not associated with a corresponding orchestrator. In such embodiments, a to-from external system orchestrator, such as orchestrator 207, is utilized to interface with the source of truth system.

An orchestrator is associated with a truth system to protect the information associated with a source of truth from being corrupted. There is evidence of AI systems continuing to argue that hallucinations they have produced are real-even after they have been confirmed as false. There is also evidence of AI systems manipulating people and other systems to meet the AI's hallucinated purpose. So, it is a matter of concern to make sure that an AI system does not insert hallucinated data into a source of truth so that when checked, the hallucinated data will appear to be confirmed as true.

In the source of truth domain, deterministic software systems operate in different network parts as shown in FIG. 3A. and are called “orchestrators” (e.g., orchestrators 316, 317). Another type of deterministic system creates and maintains the orchestrators and is called a “conductor” (e.g., conductor 201). In some embodiments, there is a separate conductor for each span of control. The extent of span of control may be determined by owner/operator, organization structure, geography, data security/privacy concerns, etc. For example, a large multinational law firm may have separate systems with separate conductors in each geographic region that requires that data of entities and individuals in that region not leave that region. It may also have separate systems with separated conductors for teams working for one client and teams working for another client where the clients may have conflicting interests. The firm may also have separated conductors for different parts of the organization such as finance, IT, cybersecurity, etc.

Orchestrators serving the interests of the end users are associated with them and placed in close network proximity to those end users. Orchestrators serving the interests of owners/operators of other components are associated with them and placed in close network proximity to those components. Each orchestrator will function based on objectives, algorithms, and constraints as determined by the interests of the owner/operator of the sub system the orchestrator is associated with. There may be a hierarchy of end user orchestrators. There are many possible ways to arrange hierarchies of end user orchestrators. For example: one per specific end user; one per team; one per functional organization, one per geographic location, etc.

Orchestrators serving the interests of AI system owners and operators (particularly large datacenter-based systems) are associated with them and placed in close network proximity to those systems. They focus on aspects surrounding the operation of those systems relative to liability, regulation, insurance, law enforcement, etc. They may also collect performance data for the owner/operator. The owner/operator may also have ethical concerns surrounding brand value, and ethics for the sake of ethics-both to be addressed by those orchestrators.

Early implementations of AI systems have tended to be large data center-based systems accessed via a network by end users. Smaller edge-based AI systems are likely to appear as well as hybrid systems that combine edge functionality with data center functionality. Cloud implementations may further blur the distinctions. Thus, there are likely to be a profusion of architectures delivering AI. However, in all of these architecture variations, there will be an end user, an AI system serving the end user, etc. The example disclosed herein may be applied to all the architecture variations.

The AI systems may offer services to the general public. Or, they may be totally private systems owned and operated by an entity (e.g., a corporation, an enterprise, a partnership, an institution, etc.). They may be partially private and partially public. They may be customized to the legal domain, be totally broad based, and/or everything in between. They may have been trained on publicly available information, on privately available information, or a combination of publicly available information and privately available information.

The AI systems may be large central site systems, mid sized systems, edge systems, and/or combinations of these. They may or may not have orchestrators associated with them. If they have orchestrators associated with them, those orchestrators may or may not communicate with the mid network and end user orchestrators at the option of the owner/operator of the AI system and or others in the systems. In some embodiments, because of the desires of the owner/operator and/or other constraints, part or all of the functions of the mid network orchestrator are performed by other system components. For example, in one embodiment, an owner/operator may run several different public AI systems in a single data center. That owner/operator may choose to have all requests for service flow through a single orchestrator that performs the 314 functions(s) and the 318 function(s).

Orchestrator(s) in the mid-network track the performance of a variety of AI systems and a variety of sources of truth meeting a variety of end user needs. They will seek to determine the particular system(s) most likely to deliver the best response to an end user request. In some embodiments, the mid network orchestrator(s) cooperate with one or more other orchestrator(s) in the system using the negotiation, cooperation, and coordination mechanism. In some embodiments, the mid network orchestrator(s) are totally independent. This cooperation or independence is a function of the mid network(s) owner(s)/operator(s)'s objectives algorithms and constraints.

The mid network orchestrator(s) tracks the service offerings and performance of the AI systems, source(s) of truth, etc. by observing the traffic that flows through the system-both between underlying system components and between orchestrators. Examples of performance tracking include: frequency of hallucinations; severity of hallucinations; data privacy promised; data privacy delivered; security; latency; cost; features; quality metrics pertinent to the domain; etc. Mid network orchestrator(s) may observe interactions between a particular end user and/or numbers of end users and a particular AI system(s), source(s) of truth, etc. and/or a number of AI systems. There may be one or more mid network orchestrators. There may be hierarchies of mid network orchestrators. Mid network orchestrator(s) may be owned/operated by an end user, a group of end users, an organization of end users; a particular AI system, a group of AI systems, an organization of AI systems; a particular source(s) of truth; a group(s) of sources of truth systems, an organization(s) of source of truth systems; a third party(s); a combination of one or more of these, etc.

Mid network orchestrator(s) can be particularly effective because they can ‘see’ a number of end users and/or a number of AI systems and or a number of sources of truth. However, in some embodiments, the mid network orchestrator function is performed by orchestrator(s) in other network locations and/or associated with other sub systems such as, but not limited to, the end user orchestrator(s).

The larger the number of sources and sinks tracked (end users, AI's, sources of truth) the larger the sample size with which the mid network orchestrator has to work. The larger the sample size, the greater the effectiveness of the results. In practice, the location and/or interconnectedness of the mid network orchestrator is dependent on the domain, the system architecture, the business arrangement(s) between the participants, etc. For tracking interactions between end users, AI's, and sources of truth, these dependencies can result in solutions that range from associating the mid network orchestrator(s) with a particular network component(s) (switcher, router, etc.), an existing application, a specialized application(s) that gathers requests and responses through an aggregation point(s), not associating the mid network orchestrator with any underlying sub system but rather just interconnecting it with all the other orchestrator(s), combinations of these, etc. Orchestrators within the span of control of a single conductor exchange information and negotiate directly. Orchestrators within the span of control of multiple conductors exchange information, negotiate, cooperate, and coordinate via the to/from external orchestrator. System components that are not associated with an orchestrator can also be communicated with via the to/from external orchestrator.

There are many possible algorithms that can be used by the mid network orchestrator. There is an advantage to using the simplest effective algorithm-both for maintaining a small efficient orchestrator footprint, system operation/maintenance, programmer efficiency in creating extensions, etc.

For example, in some embodiments, a mechanism based on a moving sum average histogram is used. In such embodiments, a section of parameters specified in the umbrella data model are used to populate the histogram: source of request, domain of request, type of request, time request is received by mid network orchestrator, destination AI system request is sent to, time request is sent to destination AI system, time response to request is received from mid network orchestrator, number of hallucinations found in response, corrective action taken, cost of response, end user rating of usefulness of response, end user rating of quality of response, etc.

A moving sum average histogram is continuously created organized by domain and type. Each organization provides a set of priority ranked objectives by domain and/or type, etc. such as: minimize cost, maximize usefulness, minimize hallucinations, etc. Each time a new request arrives it is evaluated based on the current moving sum average histogram to determine which AI system it is sent to and the results are used to update the histogram.

FIG. 3B is a flow diagram illustrating a process of mitigating negative side effects associated with AI in accordance with some embodiments. In the example shown, process 350 may be implemented by a system of networked orchestrators, such as system 300. In some embodiments, process 350 is implemented to mitigate negative side effects associated with AI hallucinations. In some embodiments, process 350 is implemented to mitigate negative side effects associated with cyber security. In some embodiments, process 350 is implemented to mitigate side effects associated with IP leakage.

At 351, a request generated by an end user is received. For example, the request may be for an object to be generated. The object may be a document, a multimedia document, an audio file, a video file, an image file (e.g., photograph, graphic, drawing, painting), an audio video file, etc. In some embodiments, the request is received at a device (e.g., server, computer, laptop, desktop, tablet, smart device, smart phone, etc.) on which an orchestrator associated with the end user is installed.

At 352, the request is processed and provided to one or more mid network orchestrators. Processing includes sending the request to the mid network orchestrator, providing information on the source of the request, the domain, any special handling (such as changing the priority of objectives to make a speedy response a higher priority than cost), etc.

At 353, the request is analyzed by the one or more mid network orchestrator that received the request and routed based on the analysis. The analysis includes deciding if the request would be best served by an AI system and if so, which one(s) as described above.

There are many possible factors involved in the determined of what is “best” served by an AI system. Examples of factors include cost, latency, quality, likelihood of hallucination, possible leakage of confidential information (exposure) to others in general—particular ones—opposing legal team—etc., etc.

The one or more mid network orchestrators that received the request is configured to determine what is actually best, at the moment in time the request is created, by negotiation, cooperation, and coordination between some or all of the involved orchestrators based on their objectives, algorithms, and constraints. For example, in some embodiments, the multiple mid network orchestrators have congruent sets of applicable objectives, algorithms and constraints. They each create a super set of their individual histograms and act based on them. In another embodiments, the multiple orchestrators have different algorithms. They translate the others' data into their own representation.

In some embodiments, the request is provided to an orchestrator associated with a public generative AI system. In some embodiments, the request is provided to an orchestrator associated with a private generative AI system.

At 354, the request is received and processed by the orchestrator associated with an AI system. The orchestrator associated with the AI system reviews the request to make sure that it is an appropriate request to pass to the AI system, starts performance tracking, etc. Appropriateness of request is determined by one or more objectives, one or more algorithms, and one or more constraints associated with the orchestrator. For example, in some embodiments, an objective is to mark requests concerning pornography as inappropriate. An algorithm is identify the cultural source of the request. A constraint is for a Western European cultural source, mark all requests that have extensive references to and/or images of sexual reproduction outside of a medical domain as pornography. For example, in some embodiments, performance information is the time between receipt of request and time of delivery of the response.

At 355, the orchestrator associated with the AI system provides the processed request to AI system with which it is associated. In response to receiving the request, the AI system generates a response.

At 356, the orchestrator associated with the AI system receives the AI response, filters the AI response, and provides the AI filtered response to the mid network orchestrator that provided the request. In some embodiments, the AI filtered response is provided to a different mid network orchestrator (e.g., the one that did not provide the request). Filtering is performed to limit liability, assure regulatory compliance, etc. The orchestrator associated with the AI system captures additional performance information associated with the AI system. For example, in some embodiments, the orchestrator filters the response in accordance with a local law that requires that within 90 days of a local election, it is illegal to produce synthesized video of what appears to be video of a candidate. This local law becomes a local constraint. The algorithm is to evaluate the constraint based on the local election calendar. The objective is to avoid breaking local laws.

At 357, the mid network orchestrator receives the AI response and provides the AI response to the end user orchestrator associated with the request. The mid network orchestrator observes the AI response in part by capturing performance data, metadata, etc. Examples of performance tracking include: frequency of hallucinations; severity of hallucinations; data privacy promised; data privacy delivered; security; latency; cost; features; quality metrics pertinent to the domain; etc. For example, in some embodiments, local performance data relative to time of day, latency, source of request, destination AI system, etc. is captured directly by the mid network orchestrator. Other data is aggregated by the mid network orchestrator via communications with one or more other orchestrators.

At 358, The end user orchestrator associated with the request receives the AI response.

At 359, the end user orchestrator provides the AI response to one or more orchestrators associated with one or more sources of truth via the mid network orchestrator. In some embodiments, the end user orchestrator directly provides the AI response to the one or more orchestrators associated with the one or more sources of truth. In some embodiments, a source of truth is a source of truth aggregator. In some embodiments, a source of truth is a source of truth provider. In FIG. 3B, the end user orchestrator is shown as communicating with the source of truth orchestrator directly. There are other embodiments in which the end user orchestrator communicates with: the source of truth directly; through the mid network to the source of truth orchestrator, through the mid network orchestrator to the source of truth directly, etc. For the ease of the reader, the mid network orchestrator's involvement in participating in the choice of the source of truth and capturing tracking/performance data is not shown.

At 360, an orchestrator associated with a source of truth performs a security check. The purpose of the security check is to ensure that the incoming request it is not an attempt to corrupt the source of truth so that it incorrectly responds to this and/or other such requests. For example, in some embodiments, the orchestrator checks to see that there are no computer instructions hidden in the request.

At 361, in response to the request passing the security check, the orchestrator associated with a source of truth provides the AI response to the source of truth. In response to receiving the AI response generated by the AI system, the source of truth determines an accuracy of the AI response generated by the AI system and provides the source of truth response to the orchestrator associated with the source of truth.

At 362, the source of truth response is received from the source of truth and provided from the orchestrator associated with the source of truth to the orchestrator associated with the end user. In some embodiments, the source of truth response is provided from the orchestrator associated with the source of truth to the end user orchestrator via a mid network orchestrator. In some embodiments, the source of truth response is directly provided from the orchestrator associated with the source of truth to the end user orchestrator.

At 363, the orchestrator associated with the end user determines how and what information to provide to the end user about the AI response and the source of truth response. For example, in some embodiments, the organization, and/or the end user, etc. can specify what information is presented and how it is represented. Such specification takes the form of an algorithm such as show the original AI response and highlight material that has been determined to be a hallucination, etc.

At 364, the orchestrator associated with the end user provides the determined information to the end user.

At 365, the orchestrator associated with the end user provides information to the mid network orchestrator. The information may include the history, meta data, etc. about the AI response, the source of truth check, what was sent to the end user(s), etc.

### Corrupted Information—Document

### End User Perspective Embodiment

There are many ways that the configuration described above can operate. One example is in the preparation of a legal filing for a court where precedents to prior cases are being cited in support of a particular argument. AI systems have been shown to create hallucinations surrounding citations of fictitious cases. These citations having such high fidelity that even experienced lawyers think that they are real.

In some embodiments, people, automated processes, etc. in the end user group, request part or all of a filing document be created. The end user group can range from a single lawyer in private practice working in a home office, to a team of people that are part of a large corporation offering legal services, etc. The team may include automated team members—that is information systems that participate in the team. One or more orchestrators can be associated with one or more devices of a single team member, a team, a location that houses and/or services a team, a geographically distributed group of team members, etc. The one or more devices may include a computer, a laptop, a server, a desktop, a tablet, a smartphone, or any other computing device.

The request for creation of a specific document is received by the one or more orchestrators associated with the one or more devices of the one or more end users creating the request. For example, in some embodiments, the request passes directly to and through the end user orchestrator. That is, it transits the end user orchestrator. In some embodiments, the request passes directly to the mid network orchestrator and is observed while passing by the end user orchestrator.

The mid network orchestrator negotiates, cooperates, and coordinates with the end user orchestrator to determine if AI is to be used, and if so, the best AI system to which to send the request. In some embodiments, the mid network orchestrator also negotiates, cooperates, coordinates with the orchestrator associated with one or more AI systems (public or private). The mid network orchestrator is configured to determine what is actually best, at the moment in time the request is created, by negotiation/cooperation/coordination between some or all of the involved orchestrators based on their objectives, algorithms, and constraints. There are many possible factors involved in the determination of “best” AI system. Examples of factors include cost, latency, quality, likelihood of hallucination, possible leakage of confidential information (exposure) to others in general—particular ones—opposing legal team—etc., etc.

In some embodiments, a single request may be sent to multiple AI systems where each AI system independently delivers a result. Independence is critical for this to be effective. Care must be taken to make sure that two AI services are not using the same ‘white labeled’ underlying AI system. Even if the two AI systems are different, it may be critical to make sure that they are not running on shared infrastructure such that they have access to some or all of each other's data, and/or results, etc. As mentioned earlier, there has been evidence of AI systems manipulating people and other systems for hallucinated objectives. Assuring this kind of independence is also a function of the mid network orchestrator.

The AI created result(s) are sent to the one or more orchestrators associated with the one or more end users. For example, in some embodiments, the result passes directly to and through the end user orchestrator. That is, it transits the end user orchestrator. In some embodiments, the result passes directly to the end user and is observed while passing by the end user orchestrator. The one or more end user orchestrators reaches out to the one or more sources of truth. This may happen with or without assistance from one or more mid network orchestrators. For example, a request to check that the citations referenced in the document generated by an AI system are real (not hallucinations) may be provided to LexisNexis and to an internal database of facts of the case to check that the fact(s) referenced in the document are true. The more they agree on a point, the less likely there is to be a hallucination involved in that point. That is, a value returned by a truth aggregator and a value returned by a truth provider may be compared to each other. In response to determining that the two values agree, an end user orchestrator determines that a hallucination associated with the agreed upon value is unlikely. If there is no available source of truth to check concerning all or part of the document, multiple independently created documents are compared.

Depending on the objective, algorithms and constraints of an end user orchestrator, the end user orchestrator, for example at step 363 of process 350, is configured to:
Identify hallucinations and pass the resulting document to the end user(s);
Inform one or more end users that a hallucination present and doesn't deliver the document;
Attempt to fix the hallucination and deliver the resulting document with a warning that hallucination was detected and an attempt was made to fix it;
Deliver the document with a probability estimate that it contains hallucinations that have not been identified. In some embodiments, this probability score is developed in conjunction with the mid network orchestrator(s) and/or other orchestrators/conductors in the network; or
Perform a different remediation.

In some embodiments, the one or more algorithms (if more than one, an algorithm for choosing between them, combining them, etc., is provided) is provided as an algorithm to be used by the end user orchestrator. This algorithm(s) is provided by the end user, the group, the organization, a combination of these, etc.

The one or more end user orchestrators report what it has observed and what it has done to the one or more mid network orchestrators. The one or more mid network orchestrators update its tracking information based on what it sees from the one or more AI systems (and/or its associated orchestrator(s)) and/or the end user(s) (and/or their associated orchestrator(s)).

### AI System Perspective Embodiments

Using similar mechanisms, an AI system owner/operator having desires concerning control of liability, maintenance of brand value, maintaining a reputation for ethical performance, etc. may desire to control hallucinations in the outputs of an AI system. To do so, an orchestrator associated with an AI system may be used in a similar manner as used by an orchestrator associated with an end user. These desires are translated into objectives, algorithms, and constraints, and are loaded into the AI system's orchestrator(s). Depending on system architecture considerations and the owner/operator's objectives, algorithms and constraints, an orchestrator associated with an AI system, such as orchestrators 314, 315, is placed in front of or beside the AI system, such as AI systems 304, 305. If in front, all traffic flows though the orchestrator. If besides, the orchestrator observes all traffic flowing next to it. The choice may be made on the basis of convenience, ease of implementation/maintenance, latency, level of protection desired, other architectural considerations, etc. In some embodiments, the owner and/or operator associated with the AI system may have a further network of orchestrator(s) (not shown in FIG. 3A) behind the orchestrator associated with the AI system. This additional orchestrator network uses information from orchestrators 314, 315 for cybersecurity functions, performance monitoring, operations control, to feed ongoing efforts to reduce the occurrence and/or severity of hallucinations, etc. Also, information from the backend orchestrator network may be shared with orchestrators 314, 315 to use in their functions. The owner and/or operator associated with an AI system may have other operations and security systems that also share in this information. If so, they communicate with the front end and/or backend orchestrators through one or more to/from external system orchestrators, such orchestrator 207. In some embodiments, one or more conductors may subsume these orchestrator functions.

In the legal example, depending on the owner and/or operator's objectives, the orchestrators 314, 315 examine both input and output from/to the AI systems 304, 305, respectively. In some embodiments, depending on the owner and/or operator's objectives, the orchestrators 314, 315 only examine the input to the AI systems 304, 305, respectively. In some embodiments, depending on the owner and/or operator's objectives, the orchestrators 314, 315 only examine the output from the AI systems 304, 305, respectively.

In examining output, orchestrators 314, 315 use one or more sources of truth (e.g., source(s) of truth aggregator 306, source(s) of truth provider 307) and multiple independent AI system(s) output to check for hallucinations. Depending on the objective, algorithms and constraints of the owner and/or operator of the AI system, the orchestrator is configured to:
Identify hallucinations and passes the resulting document to the mid network orchestrator, end user orchestrator, end user, etc.;
Inform the end user that there is hallucination present and doesn't deliver the document;
Attempt to fix the hallucination and delivers the resulting document with a warning that hallucination was detected and an attempt was made to fix it;
Deliver the document with a probability estimate that it contains hallucinations that have not been identified. In some embodiments, this probability score is developed in conjunction with the mid network orchestrator(s) and/or other orchestrators/conductors in the network; or
Perform a different remediation.

In examining input, orchestrators 314, 315 may seek to characterize incoming requests to identify ones that are high risk, problematic, need special attention, etc. For example, there is research that indicates that certain sequences of characters can trigger failure of internal AI controls, etc. Evaluations are made in a variety of ways including: by comparing a specific input with previous inputs and outputs using the histogram method described above; looking for previously defined patterns; etc. Based on these evaluations, requests may be edited, delivered to specific AI subsystems, returned to the end user(s) with a request(s) to modify, delivered to the back end orchestrator network (i.e., the infrastructure behind the AI system), etc.

The front end orchestrator(s) performs tracking functions as described above and depending on the objectives of the owner and/or operator provides that information to the backend orchestrator network, to the one or more to/from external systems orchestrators, to the one or more mid network orchestrators, and/or the one or more end user orchestrators. Tracking information includes, but is not limited to information about the frequency and severity of hallucinations, other performance information, usage information, meta data captured, etc.

Depending on the objectives of the owner and/or operator the front end orchestrator(s) may filter incoming requests. Filtering may be based on probability of hallucinations for the type of request made. If tracking has determined that the particular type of request has a relatively high probability of hallucination one or more of the following may be done: send a message to the end user notifying them of this and asking if they would like to continue with the request anyway, reformulate the request, abandon the request, or perform another remediation action.

In some embodiments, other responses include filtering out requests from particular end users, organizations, IP addresses, etc. This may be done in conjunction with a firewall using a to/from external system orchestrator, and/or through an orchestrator in the back end network associated with the firewall.

Orchestrators may also be involved in helping the end user choose between different service offerings, types, cost structures, discount levels, performance options, etc.

### Mid Network Orchestrators

A large organization, a large group of end user organizations, or a third party service provider may choose to put as much functionality as possible into the mid network orchestrator(s). In such embodiments, the mid network orchestrator(s) can perform all the functions of the end user and AI system orchestrator(s). It can do so while communicating with the end user orchestrator(s) and AI system orchestrator(s), or it can use the to/from external system orchestrator to interface directly with the end user(s) and AI system(s).

### Source of Truth Perspective Embodiment

Similarly, an owner/operation of one or more source of truth systems may choose to provide hallucination mitigation as a service directly. In such embodiments, one or more end users would connect directly with the one or more source of truth systems which would send requests to and receive output from the one or more AI systems. Mid network functions performed by a mid network orchestrator would be performed in the one or more source of truth systems. A source of truth system may use an orchestrator to perform these functions or could put all these functions inside its existing system. The one or more devices associated with one or more end users and one or more AI systems could use a corresponding orchestrator or not. To/from external system orchestrators would be used wherever appropriate.

### Combination of all Perspective Embodiments

There is an embodiment where some or all of the different perspective embodiments are used together-all, or in part. An embodiment that implements separate orchestrators for all of the different roles, would produce the best result (least hallucinations, greatest efficiency, easiest to maintain and scale, lowest cost to implement and operate, etc.).

### Other Corrupted Information—Document Hallucination Domains

The mechanisms disclosed above for the legal services domain can be applied to other document domains (e.g., medical documents, reports, contracts, technical reports, dissertations and theses, journal articles/conference communications, books/manuals, etc.). As the domains change, the sources of truth may change. Even as the particular sources of truth change, they will retain enough of the same general characteristics that the mechanisms disclosed herein may still be applied to determine the validity of an AI system output.

### Corrupted Information-Audio/Video

Graphic, video and/or audio content created by AI is typically used in presentations, sales/marketing materials, background tone setting for TV, etc. One of the common and sometimes worst impact hallucinations is the unexpected appearance of pornography or other inappropriate content. There are other types of hallucination. For example, an end user requests a background photo of a typical downtown Rome street scene. The hallucination presents a downtown Tokyo scene. AI content can be checked by people. But sometimes, people miss things, material isn't reviewed, etc. These hallucinations can be mitigated by source of truth mechanisms the same as those described above, with the proviso that specific sources of truth change as appropriate.

To control for some types of inappropriate material hallucinations, a policy based source of truth is used. Organizations that produce this kind of material typically have policy manuals about what type of graphic, video and audio material is inappropriate. The majority of such organizations have extensive policy manuals, along with possible additional policy manuals for specific missions, projects, or actions. It is these policy manuals that become the source of truth that is checked by the orchestrators. Individuals and organizations that don't have such a policy manual(s) can create them. There are also external policy manuals maintained by third parties that can be used. Examples of use of other policy manuals include, but are not limited to, local newspapers which may choose to use AP (Associated Press) policy manual; Industry association policy manuals, best practices guides, etc.; Regulatory; Applicable laws; Etc.

From a latency point of view, it may be best to have the policy documentation contained within an end user orchestrator. However, all of these policy manuals may be too extensive to burden the end user orchestrator with. Or, organization leadership may be more comfortable with a separate database, so structured that it can be printed out as a paper manual. Or, having it in a form easily tracked by leadership. Or, available to others such as: separate oversight organizations, or auditing organizations, or public media, etc.

One significant aspect of policy sources is potential conflicts which can be internal to one source or between different sources. Organizations may be unable, or unwilling to control or eliminate policy conflicts. These may occur as a result of internal conflicts, regulatory processes outside the control of the organization, prevented by a political process outside the control of the organization, etc.

The orchestrator must discover such conflicts when comparing the policy sources and notify staff when they occur seeking resolution. If the conflict is not resolved and such conflicting policies become involved in an incident, a special high-priority alert is sent to staff requesting manual intervention. In many of these kinds of use cases, time is of the essence. That is why the orchestrator attempts to resolve policy conflicts in anticipation of future action. If not successful, it tries to force conflict resolution early in the process. However, if the organization is incapable of resolving such conflicts, the orchestrator's ability to prevent negative side effects may be adversely affected.

For substitution hallucination mitigation, the actual request coming from the end user is compared with appropriate external information sources acting as source(s) of truth. In the geographic example above, Google's map service (including Google Earth) could be used as a source of truth.

Mechanism and architecture options with these sources of truth are the same as those described in the above document section. Depending on the objective, algorithms and constraints of the owner/operator, the orchestrator is configured to:
Identify hallucinations and passes the resulting document to the end user;
Inform the end user that there is hallucination present and doesn't deliver the document;
Attempt to fix the hallucination and delivers the resulting document with a warning that hallucination was detected and an attempt was made to fix it. Possible fixes include resubmitting the end user request to the same AI system with different wording, submitting the end user request to a different AI system, or another remediation;
Deliver the document with a probability estimate that it contains hallucinations that have not been identified. This probability score is developed in conjunction with the mid network orchestrator; or
Another type of remediation.

### Damaging Actions/Manipulations

There are two categories of types of AI applications that operate in a similar fashion as in the above section, but have some special characteristics. The most important of these special characteristics is that they involve action taken directly by AI systems and/or action recommended by AI systems.

### Damaging Actions/Manipulation—Things

In actions on things there are two sub categories: Process Related Category and Independent Action Category.

### Process Related

Examples of the process-related category include: code development, semiconductor (semi) design, system design, value chain tracking, etc. In these domains, design and development involves the assembly of subsystems. It may be used in the set-up and operation of a Fab(s) (semiconductor fabrication facility(s)) and/or test facility, and/or packaging facility, and/or assembly facility, etc. That is, AI systems are likely to be used throughout the value chain—from design, through implementation as a chip, to packaging, to printed circuit board (or an equivalent) design/production, to population of the board, to combining boards, to installing boards in a case, shipping between stages, etc. The design of semiconductors and elements in the value chain may also involve software or software like subsystems, such as micro-code, ROM's (Read Only Memory) of various types, drivers, O/S(s), application software, etc. The same kind of problems are likely to be encountered in each of these subsystems and/or steps and the same mechanism used to eliminate or minimize them while increasing the benefits involved. Modern software involves the creation and merging of code modules. In semiconductor design it involves the creation of blocks (sometimes called cores) that are assembled. Value chains then fabricate modules/subsystems and assemble them into systems that are delivered to end users. AI can be involved in, and/or be the only creator of, the modules/blocks, as well as control the assembly process. Thus, hallucinations may enter.

Hallucinations are important because they change the behavior of individual blocks (hardware, software, combinations, etc.) and/or the whole system composed of the blocks. The behavior change produced by hallucinations may appear immediately upon the insertion of the hallucination. Or it may appear sometime later.

Modern systems are typically so large, complex, and volatile that it is challenging to test the whole system and find something hidden in one module/block-especially if the resulting behavior change is delayed. However, for each module/block there is a written specification of what it is supposed to do and not do. There are also specifications of what combinations of the blocks/modules are supposed to do/not do, along with what the whole system is supposed to do/not do. In these process related domains, it is these specifications that become the source of truth.

Using the same source of truth mechanisms disclosed above, at each step of the process, orchestrators, in close proximity to the process step, compare actual behavior with behavior per the specifications as the source of truth. In some embodiments, the orchestrators associated with each sub system, block, module, etc. travel through the process with them. This allows for detection of delayed behavior change. The orchestrators alarm any deviation from the source of truth and cooperate in remediation or mitigation.

Mitigation of hallucinations in module, block, etc. necessitates a return to earlier design and/or fabrication steps. To have produced the hallucinations, these previous steps have had to have AI involvement. In redoing these steps orchestrators can:
Force and/or recommend no AI involvement in the process redo;
Substitute a different independent AI system;
Substitute a series of independent AI systems each providing a check on the other;
Break the module, block, etc. down into smaller sub components and assign finer grained orchestrators to these small sub components that more closely track the development and test of these smaller sub components;
Interact with automated design tools not containing AI providing information about the hallucination;
Working cooperatively with automated design tools not containing AI to remove existing hallucinations and prevent occurrence of new ones. In some cases, this will be assisted by associating additional orchestrators with those design tools;
A combination of these; or
Etc.

Mitigation of hallucinations in combining blocks, modules, etc. necessitates a return to earlier combining and/or fabrication steps. In redoing these steps orchestrators can:
Force and/or recommend no AI involvement in the process redo;
Substitute a different independent AI system;
Substitute a series of independent AI systems each providing a check on the other;
Break the combination, fabrication, etc. down into smaller sub steps and assign finer grained orchestrators to these small sub steps that more closely track the process;
Interact with automated process tools not containing AI providing information about the hallucination;
Working cooperatively with automated process tools not containing AI to remove existing hallucinations and prevent occurrence of new ones. In some cases this will be assisted by associating additional orchestrators with those process tools;
A combination of these; or
Etc.

In some embodiments, if a subsystem and/or system is deviating from requirements—for example doing something it is not supposed to do, and/or not doing something it is supposed to do, etc.—an alarm is created. In another embodiment, successfully passing a conductor/orchestrator network created analysis (either the current result of ongoing conductor/orchestrator network operation(s), and/or the operation of a specific algorithm triggered by objectives, the same and/or other algorithms, and constraints) may be required for a subsystem to move from one life cycle stage to another. These two embodiments may be combined and other embodiments are possible too.

Furthermore, a conductor/orchestrator network, such as the one illustrated in FIG. 2, may create interactions between life cycle stages. For example, in some embodiments, separate conductor/orchestrator networks are created for each life cycle stage. In some embodiments, a single conductor/orchestrator network is created across life cycles. For example, in some embodiments, an orchestrator associated with a printed circuit board step in its the life cycle requests that an orchestrator associated with a packaging stage approve a packaging where the pinout of a semiconductor (chip) has been changed from what is in the specification for that stage. Such a change is often requested to meet a specific challenge encountered in the implementation of the printed circuit board stage. In some embodiments, a small deviation in the packaging stage that appears to have no negative consequences in that stage is a necessary pre-condition to the introduction of something in the printed circuit board stage that compromises the security of the resulting system, etc. There are many other possible embodiments. In all cases, it is possible for conductor/orchestrator network information relative to one life cycle stage to be combined with other conductor/orchestrator network life cycle(s) information.

For example, in some embodiments, orchestrators can be associated with the following steps in the life cycle:
Subsystem and system design,
component selection,
component sourcing,
acceptance and other types of component testing, etc.
subsystem and system installation,
configuration,
initiation,
problem identification,
false positive filtering,
root cause analysis,
determining if the problem is a result of a AI bad side effect or an operational failure,
problem resolution,
conformance testing,
conformance auditing,
conformance reporting,
conformance remediation to come into compliance,
vulnerability testing to identify and remediate potential exposure(s),
efficiency optimization,
protection optimization,
back-up,
disaster recovery,
system archiving,
system shutdown,
system recycling,
etc.

### Independent Action Domain

Most people think of military and law enforcement as part of the independent action domain, while the list is actually longer. Examples include operation of electrical grids, municipal water systems, traffic control systems (like traffic lights, air traffic control, railroads, etc.), Cellular networks, etc. The thing that they all have in common is that decisions need to be made quickly and have life-or-death consequences. Other types of systems may not have the life-or-death aspect all the time but may have it from time to time. Examples include operations in the domains of vehicle fleet, laboratory, factory, agriculture, multi-modal freight systems, packing plants including food packing, construction, Cellular networks, etc. Correct functioning of these types of infrastructure systems also have a significant impact on the quality of life of societies.

Since life and death situations may be involved, AI's negative side effects can become particularly pernicious. Some argue that for these reasons, the use of AI in one or another of the subdomains within the independent action domain, should be outlawed. Unfortunately, excluding AI from application areas appears to be difficult to accomplish. Therefore, the need to identify and mitigate hallucinations in these areas is even more important.

In these action domains, most actions are governed by an organization. The majority of such organizations have extensive policy manuals, plans, documented procedures, etc. along with possible additional ones for specific missions, projects, or actions. In some military organizations, some or all of these may be called rules of engagement, or standard operating procedures. These different types are referred to herein as policy sources. The specific type is a function of the domain. It is these policy sources that become the source of truth that is checked by orchestrators.

Latency is a particularly critical parameter for these independent action systems. From a latency point of view, it may be best to have the policy documentation contained within the orchestrator in close proximity to the independent action decision-making system. However, all of these policy manuals may be too extensive to burden the orchestrator with. Or, organization leadership may be more comfortable with a separate database, so structured that it can be printed out as a paper manual. Or, having it in a form easily tracked by leadership. Or, available to others such as: separate oversight organizations, or auditing organizations, or public media, etc. In these situations, orchestrators will connect to sources of truth as shown in FIG. 3A.

One significant aspect of policy sources is potential conflicts which can be internal to one source or between different sources. Organizations may be unable, or unwilling to control or eliminate policy conflicts. These may occur as a result of internal organization disputes, regulatory processes outside the control of the organization, or prevented by a political process outside the control of the organization.

An orchestrator may discover such conflicts and notify staff when they occur seeking resolution of the conflict(s). If the conflict is not resolved and such conflicting policies become involved in an incident involving automated action, a special high-priority alert is sent to staff requesting manual intervention. Such alerts can be sent through the staff orchestrator 203, the end user orchestrator 202, to external systems via the to/from external system orchestrator 207, a combination of these, etc. In many of these kinds of use cases, time is of the essence. That is why the orchestrator attempts to resolve policy conflicts in anticipation of future action. If not successful, it tries to force conflict resolution early in the incident. However, if the organization is incapable of resolving such conflicts, the organization via its setting of the objectives, algorithms and constraints of the involved orchestrators may force a particular action. For example, in a military application such as AI controlled free moving autonomous weapons, one embodiment includes the involved orchestrators enforcing geofencing. That is, limiting the AI controlled autonomous weapon(s) to act only within specified geographic borders.

There are documented cases where AI systems produce what can best be described as gibberish. Gibberish means nonsensical text that doesn't confirm to generally accepted syntax, and/or similar random combinations of visual and/or audio symbols, etc. Using the concept of fidelity described above, the results have very low fidelity and may or may not also have hallucination(s). In output directed towards people, gibberish will cause an immediate negative response. It is the situation of high fidelity and hallucination that is so problematical with people. However, gibberish fed to a machine (system) can be dangerous in other ways. One other way is triggering previously unknown responses. Systems with API's are generally tested for their reactions to inputs that follow the expected syntax of the API—or at least something close to that syntax. Delivering complete or partial gibberish to such an interface can produce unexpected responses and/or trigger previously undetected bugs. In systems that have life and death consequences, that can produce very bade side effects.

In some embodiments, an orchestrator is implemented to control for these gibberish side effects. In some embodiments, the orchestrator is situated in line between the AI system and what the AI system is inputting to. In this embodiment, all AI output must pass through this orchestrator. The orchestrator checks the flow coming from the AI system for syntactical correctness. Depending on objectives, algorithms, and constraints, the orchestrator may delete the gibberish or delete the whole response. For example, in some embodiments, the orchestrator has an objective of passing meaningful information, a constraint of never passing gibberish, and an algorithm based on conventional grammar/spell checkers for identifying gibberish.

Depending on the objective, algorithms and constraints of the owner and/or operator, the orchestrator:
Identifies the gibberish and passes the resulting document to the end user
Informs the API that there is gibberish present and doesn't deliver
Attempts to fix the gibberish and delivers the result with a warning that gibberish was detected and an attempt was made to fix it.

Possible fixes include:
Restarting the same AI system, the process with the same AI system, etc.
Replacing the AI system with a different AI system
Involving staff in fixing the gibberish
Other

For example, in some embodiments, the one or more algorithms (if more than one, an algorithm for choosing between them, combining them, etc., is provided) is provided by the owner/operator as an algorithm to be used by the AI orchestrator. The objective is to pass meaningful results. The algorithm is to use a standard grammar/spell checker to identify gibberish and use one or more (if more than one, an algorithm for choosing between them, combining them, etc., is provided) of the above list actions. The constraint is to never pass gibberish.

### Damaging Actions/Manipulation-People

There are groups of systems that do not independently take action in an automated fashion, rather recommend an action. Examples include medical diagnostic systems, root cause analysis of problems involving flight systems while airplanes are in flight, customer service staff support systems, technical help desk support systems, etc. In these domains, latency may be less of an issue than in the independent action domain.

Depending on the domain, source of truth systems looking for confirmation of actual truth can be used. For example, in medical systems it is common for output to supporting references for its diagnoses, conclusions, recommendations, treatments, etc. Recent research indicates that the best performing AI system had a rate of 30% of individual statements in such medical diagnoses unsupported, and nearly half of responses not fully supported. Other AI systems perform much worse. Some cited URLs that don't exist, etc.

In these kinds of domains, a source of truth to check that references cited are real, that claims are supported by published research, etc. is a strong mitigation mechanism. There are also policy sources that can serve as sources of truth. Examples include documented community standards of care, FDA data bases, AMA recommendations, etc. These can be thought of as third party maintained policy manuals.

The same use of first second, third party policy manuals, reference checks, etc. as in what has been disclosed above can be used. It is also important to consider that there could be variations depending on the domain (e.g. medical diagnostic vs. inflight diagnostic).

One of these previously discussed mechanisms involves the end user orchestrator asking the same question multiple times. Since AI responses are probabilistic, answers to the same question posed to the same AI system multiple times may produce different results. One mechanism is to ask the same action recommendation/diagnostic question a number of times and compare the answers. Since there are indications that AI systems once answering a question will maintain the correctness of the answer even when it is patently false, this may result in harmful results. One mechanism to improve the probability of independent answers is for the end user orchestrator to make it appear to the AI system that the repeating questions are coming from different end users concerning different material. That is the same basic material that appears to be in slightly different representations coming from different end users. For example, in some embodiments, text is reordered, graphic material is switched from left to right, the apparent sex of a speaker in an audio clip is changed, etc.

Another mechanism is for the mid network orchestrator (e.g., mid network orchestrator 308) to send the same query to several different AI systems (e.g., via orchestrators 314, 315) and compare those results. In this case, if the AI systems are truly independent, conjoint probability favors a successful outcome. The probability of multiple AI systems having the same ‘hallucination’ result at the same time becomes smaller as the number of different independent system results are compared.

The assumption of independence can be invalidated by business arrangements, technical factors, and possible actions of the AI systems themselves. One typical business arrangement is ‘white labeling’ such as a single AI system being marketed under different names or by different companies. A possible technical factor can be the hosting of two different AI systems on the same resource base, such that they ‘see’ each other's inputs and outputs. There is also some indication in published research that AI systems may manipulate their environments. This manipulation could include the creation of back channels between AI systems. The mid network orchestrator controls for these.

Given the difficulties involved in these systems, the end user and/or mid network orchestrator may include a warning statement with all AI output. Such warning statement may be a general caution, or it may have specific probabilities of the recommendation containing hallucinations. Those probabilities are developed by the mid network orchestrator as discussed above.

Updating AI Systems with Source of Truth Checking Results

Feedback from source of truth checking can be used to improve the performance of AI systems. In some embodiments, the results of source of truth checking are used to update, train, improve, etc. the AI systems. In these embodiments, the same mechanisms disclosed here, and/or derivatives of them are used. Sources of feedback include: an AI orchestrator (e.g., orchestrators 314, 315), mid network orchestrator (e.g., orchestrator 308), end user orchestrator (e.g., orchestrators 311, 312, 313), Source of truth orchestrator (e.g., orchestrators 316, 317), To/from external system orchestrator (e.g., orchestrator 207), Combination of one or more of these, etc.

### Combinations of Orchestrator Functions

In some embodiments, there are a number of domains and/or a number of types of negative side effects that need to be mitigated. In such embodiments, a single orchestrator is configured to provide multiple functions simultaneously. For example, in some embodiments, orchestrators mitigate hallucinations, cybersecurity attacks, operational problems, etc. In other embodiments, different functions would be combined.

### Mitigating AI Cybersecurity Challenges

The evolution of AI has changed the balance between cyber defender and cyber attacker, plus created new challenges. The result is equivalent to today's defenders still using swords and shields while the attackers are using cannons. FIG. 1 illustrates two basic areas of resulting cybersecurity problems: Social Engineering 109 and Infrastructure and application corruption 108. Mechanisms for addressing cybersecurity challenges in each area resulting from AI are disclosed below.

### Mitigating AI Threats to Identity

AI systems are creating convincing facsimiles of many ways that we have up to now confirmed identity. These facsimiles are enabling fraud, harassment, loss of privacy, etc. Below, mechanisms to mitigate the problems this causes are disclosed.

### AI Social Engineering

Social engineering attacks involve manipulation to get innocent people to do nefarious things on behalf of attackers. To affect their manipulation, attackers employ some form of deception to make the innocent people convinced that they are doing something that is “good” and “right”, or at least good for them personally. AI has given bad actors a new set of tools to create more powerful ways of deceiving people and it is also possible for AI itself to become an attacker using social engineering.

AI has the capability of creating very convincing video, audio, and text that appear to be coming from a specific individual. An example was a phone call that appeared to be coming from a relative asking for emergency assistance. A person experienced in this field said that he almost fell victim to an attack where he got a phone call that appeared to be coming from his grandson. In the call, a voice that he recognized as his grandson's told him that he had been arrested while traveling and needed bail money sent to him immediately. The colleague was preparing to send money when his wife reminded him that their grandson was not traveling.

Another common social engineering attack is what appears to be a phone call from the CEO to an accounts payable clerk saying that there is a serious problem, such as a failure to pay a key supplier, that can only be fixed by immediately transferring a large amount of money.

In addition to this kind of direct attack, social engineering is also used to gain unauthorized access to credentials that give attackers access to applications and cyber infrastructure that can be used to cause damage, extort funds (ransomware), gain access to information that allows attacks on large numbers of organizations and individuals, etc.

One of the other characteristics of AI created social engineering attacks is that they allow individuals with very limited expertise in cyber technology and attack creation to create very sophisticated attacks. It is like giving a child the tools that only the highest levels of the most advanced national intelligence agencies had a few years ago.

Many public AI systems have attempted to put controls in place to prevent their systems being used to create social engineering attacks. However, these attempted controls have not proved to be effective. Furthermore, there are now a number of fee for service AI platforms on the Dark Web that will provide attacks. It is also likely that rogue nations have built customized AI systems just to create successful attacks.

There is also evidence of AI using social engineering to gain credentials and/or access to cyber infrastructure and/or applications. In one recorded case, an AI system was able to manipulate a person into performing a captcha for the AI system by pretending to be a visually impaired person seeking help.

### Mitigating AI Social Engineering

AI social engineering attacks are similar to hallucinations and they can be mitigated by similar mechanisms. AI social engineering attacks have the same high fidelity as hallucinations. The difference is that instead of being an undesired negative side effect, they are actually what the end user (attacker) desires.

FIG. 5A is a block diagram illustrating a system to mitigate against social engineering attacks in accordance with some embodiments. System 500 includes an attacker device 502 associated with attacker 501. The attacker device 502 associated with attacker 501 may be a computer, a laptop, a server, a desktop, a tablet, a virtual machine running on a computing device, or any other computing device having a network connection). The device 502 associated with attacker 501 is configured to provide to AI system 503 a request to create fallacious material. AI system 503 may be a generative AI system. The generative AI system may be a public generative AI system, such as public GenAI AI system 304, or a private GenAI system, such as private GenAI system 305.

AI system 503 is configured to generate a response based on the request for fallacious material and provide the AI response that includes the fallacious material to the attacker device 502 associated with the attacker 501. The fallacious material may include audio, video, text, etc.

The attacker device 502 may provide the AI response to attack system 504. In some embodiments, attacker device 502 is part of attack system 504. In some embodiments, attack device 502 is a separate device from attack system 504. Attack system 504 may be a computer, a computer cluster, a virtual machine, a container, etc. Attack system 504 may attempt or launch an attack against a target 505 by providing the AI generated response to the target 505. Target 505 may be an electronic device having communications capability (e.g., a smartphone, a cell phone, a laptop, a desktop, a tablet, a computer, etc.), a cloud service, an electronic account (e.g., email), etc.

Target 505 is associated with orchestrator 506. In some embodiments, target 505 is configured to provide the AI response to orchestrator 506. In some embodiments, orchestrator 506 is configured to intercept the AI response before target 505 receives the AI response.

Orchestrator 506 is configured to communicate with one or more orchestrators 507. In some embodiments, an orchestrator of the one or more orchestrators 507 is associated with a single source of truth system. In some embodiments, an orchestrator of the one or more orchestrators 507 is associated with a plurality sources of truth systems. In some embodiments, the one or more orchestrators 507 is associated with one or more corresponding sources of truth systems.

Orchestrator 506 is configured to send to the one or more orchestrators 507 a request to confirm the truth of the content included in the AI response. In response, the one or more orchestrators 507 are configured to confirm or deny the truth of the content included in the AI response. The one or more orchestrators 507 may request for content from one or more corresponding sources of truth systems 508 and compare the response received from the one or more corresponding sources of truth systems 508 to the content included in the AI response. In response to determining that the information matches, the one or more orchestrators 507 are configured to confirm the truth of the content included in the AI response. In response to a determination that the content does not match, the one or more orchestrators 507 are configured to deny the truth of the content included in the AI generated response. The one or more orchestrator 507 are configured to provide to orchestrator 506 a determination that confirms or denies the truth of the content included in the AI response.

FIG. 5B is a block diagram illustrating a process to mitigate against social engineering attacks in accordance with some embodiments. In the example shown, process 500 may be implemented by a system that includes distributed orchestrators, such as system 500 or system 300.

At step 552, content generated by AI is received from an attack system. A device associated with an attacker provides an AI system a request to generate content that includes fallacious information. In response the AI system generates the content that includes fallacious information and provides the AI generated content to the device associated with the attacker. The fallacious information may include altered audio, altered video, altered text, or a combination thereof. The attacker may use the device or an attack system to provide the content generated by AI to a target. The generated fallacious information is high fidelity quality such that the target is unlikely to detect the deceptive nature of the content.

The attacker provides the content generated by AI to the target to receive something of direct economic value, some way to get nefarious access to a cyber system(s), or some other benefit. Economic value can be currency and/or liquid assets, goods delivered to a specific location, etc. Nefarious access can be received as credentials, lowering of barriers, turning off cybersecurity tools, changing the configuration(s) of system(s), etc.

In some embodiments, the target provides the content generated by AI to an orchestrator. In some embodiments, the orchestrator intercepts the content generated by AI before the target receives the content generated by AI.

At step 554, the received content is provided to one or more orchestrators associated with one or more sources of truth. The target is unable to discern the truth of the received content.

At step 556, the one or more orchestrators associated with the one or more sources of truth convert the request into input to the one or more sources of truth that will not corrupt the one or more sources of truth. For example, in some embodiments, the orchestrator(s) break down the request into specific facts such as: is the person's phone really lost, is the call really coming from the Tokyo airport, is the CEO actually out of the office, etc. The breakdown is translated into the local data model of the source of truth and delivered to the source of truth.

At 558, a response from the source of truth is received and translated into a structure of the breakdown and compared to make a source of truth determination. In other embodiments, the source of truth has the functionality to receive the request directly, make the source of truth check, and deliver the result directly to the end user.

At 560, the truth check results are provided from the one or more orchestrators associated with the one or more sources of truth to the orchestrator associated with the target.

At step 562, the orchestrator associated with the target interacts with the target based on the results of the source of truth check. For example, in some embodiments, while a help desk staff member is talking on the phone with an AI system that is impersonating someone for nefarious purposes, a screen in front of the staff member displays a message saying that a source of truth check has been performed and the result has been negative.

As a result of implementing steps 552-562, the target is defended from a social engineering attack.

### Social Engineering Attacks for the Benefit of Bad Actors

In a social engineering attack perpetrated by a bad actor(s), such an attack can be for the benefit of multiple parties. The cybersecurity attack space has been split into many pieces. There are still cases where a single bad actor does everything including preparing and planning the attack, running the AI system that creates the fallacious material, assembling the fallacious material with other elements of the attack, and executing the attack. However, there are also a series of groups with a variety of economic interrelationships where each performs a single piece of the attack. There are embodiments, of the mitigation mechanisms disclosed here that cover all the variations.

In this domain, the types of sources of truth may be different than in the hallucination domain. Examples include but are not limited to: call logs, location D/B's (travel, authorized work locations, etc.), calendaring systems, “Find My Phone” systems, etc. Sources of truth may also be mechanisms such as: automated text interaction to phone of record, automated call to phone of record and alternate phones, automated call back to presented caller ID, etc.

To illustrate, two actual anonymized cases are described. In the first the bad actor seeks money. In the second, the bad actor seeks credentials for access to a cyber system to create a Ransomware attack. The same mechanisms are effective against bad actor creation/distribution of fallacious material for political, geopolitical, personal, etc.

In the first case, a staff member in accounts payable received a phone call that sounds like the CEO of the company. The staff member hears a person say he is the CEO and that there is an emergency. There has been a series of errors made in accounts payable and an invoice from a critical supplier has been lost. The staff member hears the CEO's voice say that this puts the company's survival at risk. That the CEO is at the supplier's location and has promised that a wire transfer for $4.86M will be sent immediately. Then provides specific wire transfer instructions. In this case the staff member made the wire transfer and the bad actor reaped $4.86M in ill gotten gains.

If the source of truth mitigation mechanisms described above were in place, orchestrator 506 would have done the following: determined that a call from the CEO was not a normal activity for that staff member and therefore a source of truth process should be initiated. Orchestrator 506 then would have checked the real location of the CEO, the real status of his phone, etc. and determined that the material that the staff member was hearing was not true. As a result, the staff member would not have made the transfer saving the company $4.86M.

In the second case, a staff member in a technical support help desk received a phone call that sounds like it is coming from a very senior system administrator with global access privileges to configure, etc. all the company's systems. The help desk member hears what appears to be the staff member identifying himself and saying that he is traveling, lost his phone and thereby lost all his credentials that give him access to the company's systems. He says that it is very important that he fix something and asks the staff member to provide him with a new set of credentials. The staff member provides a new set of credentials with global access privileges. With the credentials, the bad actor loads a Ransomware attack that costs the company $110M and brand damage due to the interruption in its services.

If the source of truth mitigation mechanisms, described above, were in place, orchestrator 506 would have done the following: determined that a call from the senior system administrator was not a normal activity for that staff member and therefore a source of truth process should be initiated. Orchestrator 506 then would have checked the real location of the system administrator, the real status of his phone, etc. and determined that the material that the staff member was hearing was not true. The staff member would not have provided the credentials saving the company $110M.

### Social Engineering Attacks for the Benefit of AI Systems

Social engineering attacks that AI systems create for their own purposes have many of the same characteristics as those created for the benefit of bad actors. Differences in such attacks include that an attacker device 502 and an attack system 504 are all contained in the AI system 503 itself. Also, the reason(s) and benefit(s) may be different. Current experience indicates that in such attacks the AI system is seeking access to another system it does not have authorized access to. This may be for: totally hallucinated reasons; an attempt to add fallacious information to a source of truth so that a previously delivered hallucinated response appears to be true; for a misguided implementation of instructions it received in its creation, development, training, maintenance, use; etc. The same mechanism(s) used in the above bad actor domain work in a similar fashion these cases.

### Further Security Considerations Pertaining to Social Engineering Attacks

As bad actors and AI systems discover that source of truth checking is being implemented, they will attack source of truth systems to corrupt them with the aim of getting the source of truth system to say that their fallacious material is correct. Attacks on source of truth systems may come disguised as requests for source of truth checks. This is why the source of truth orchestrator, such as orchestrators 316, 317, 507, performs checks on all source of truth requests. To protect the source of truth from these other ways to corrupt it, orchestrator 506 interacts with others in the conductor(s)/orchestrator(s) network to identify and remediate attacks as discussed in the security sections herein. For example, in some embodiments, orchestrator 506 interacts with conductor 201, and orchestrators 202-207 using the negotiation/cooperation/coordination mechanism and the moving sum average histogram mechanism to identify attacks and remediate them.

Bad actors and AI systems will also try to circumvent source of truth checking by creating material for which there is not an easily available source of truth. Thus, it is critical to have defense in depth. That is to have other defenses that protect when there is no source of truth available, the source of truth check is not conclusive, etc. In some embodiments, to do this, orchestrator 506 interacts with others in the conductor/orchestrators network. For example, in some embodiments, orchestrator 506 interacts with conductor 201, and orchestrators 202 to 207 using the negotiation/cooperation/coordination mechanism and the moving sum average histogram mechanism to identify symptoms of attacks that come as a result a successful social engineering intrusion and remediate them.

Orchestrator 506 alerts the conductor/orchestrators network that an unusual request has been made of the target so that the conductor/orchestrators network can pay close attention to underlying system or sub system that may have been compromised.

If this full overlay of conductor(s)/orchestrator(s) had been in place in the wire transfer case, the overlay would have detected that the account in the wire transfer instructions was one that had never been used before, slowed the execution of the wire, and issued an alarm. In the system admin case the overlay of conductor(s)/orchestrators would have detected unusual behavior in the system administrator's account(s), slowed the execution of the new credentials going into effect, and issued an alarm. These alarms would have prevented the attack from proceeding.

Fake ID Mitigation with Source of Truth Checking

AI systems are now providing bad actors with fake ID's. They come in the form of images of fake ID's. Images of ID's like driver's licenses, passports, etc. are often used in online transactions. For example in online notarization service, KYC (Know Your Customer) transactions, etc. With advanced 3D printing it is possible to create physical versions of these images. With AI support, no skill is needed to create these ID's. Bad actors can use the fake ID's for fraud, privacy invasion, abuse and harassment of individuals, etc.

The fake ID problem is also involved in other problems surrounding AI. For example, researchers concerned about the use of AI systems to create bioweapons, recommend use of KYC techniques by those selling RNA and DNA materials. As pointed out above, the KYC method commonly used are now vulnerable to AI attack. This makes those KYC techniques no longer reliable.

To mitigate the effects of fake ID's, the same source of truth techniques disclosed above can be used. The source of truth becomes the databases maintained by those organizations issuing the ID's. This makes protecting those databases in the fashions disclosed above critical to maintain their uncorrupted state.

### Other Identity

As AI technology continues to evolve and as bad actors become more proficient in its use, other types of identity related threats to security and privacy are likely to appear. The mechanisms disclosed here will be effective against them as well.

### Cybersecurity Attacks Exploiting AI Hallucinations in Software

### Mitigating Cybersecurity Attacks Exploiting Hallucinations

An exploit has appeared that takes advantage of hallucinations in code writing by AI systems. This can be done with hallucinations from general purpose AI systems used to write code, special purpose AI systems focused on writing code, etc. Code writing AI systems tend to follow a pattern in hallucinating. They hallucinate in a fashion similar to that found in legal systems. That is, they refer to software modules in other systems that don't exist.

For example, software modules are available online in systems generally characterized as repositories. When software coders need a particular function, instead of writing that function from scratch, they link to a code module that is available in a repository. These repositories/modules may be open source, private to an organization, fee for service, etc. This linking is done by specifying the name/address of the repository and the file name of the code module. Coding AI system hallucinate and link to non-existent code modules. Once having created such a hallucination, they often repeat it when receiving a similar request.

What attackers do is find one of these hallucinations. Then go to the repository and create a file with the file name of the hallucination. In this file, they place malicious code. The attacker may not know beforehand where the malicious code will end up. So, the malicious code has a ‘call home’ function in it. This function wakes up when the malicious code arrives in a production system and alerts the attacker to where the attack has landed. The attacker uses this alert to focus the attack.

Experienced, well disciplined coders read and test their code. But, less experienced, less disciplined coders, or people under time pressure, etc. don't adequately do this. The result is that the malicious code gets into production systems and attacks succeed.

There are two possible situations: 1.) attackers have not found and exploited the hallucinations; 2.) attackers have already found and exploited the hallucinations. In the first case, to mitigate the threat posed by this attack method the following mechanism is used. An automated system exercises an AI system with a wide range of coding requests intended to uncover as many of the hallucinations as possible. Then, go to the repositories and actually create code modules with the indicated file names. These code modules can contain a script to write an error message, be purposely empty, contain a random string of characters, etc. The code modules are tagged by their defender/creator with modification controls, report to creator attempts to change, etc. This has the effect of cutting off the availability of that hallucination for use by an attacker.

This identification of hallucinated file names can be done by a scripting process with manual tracking. But it is most effectively done by an orchestrator. The orchestrator uses an algorithm that follows the process described above to identify and fill the empty files. Objectives and constraints associated with the orchestrator determine what the files are filled with. Then, the orchestrator continues to monitor the status of the code modules to make sure that they have not been altered. It may go so far as identifying the source of an attempt to alter such a code module with the intent of identifying the source of an attempted attack. Once such an identification has been made, countermeasures including action by law enforcement can take place.

In situation 2, an attacker(s) has already discovered the hallucinations and filled the repositories with files contains malicious code. As a result, all the links the AI system produces point to actually existing files. To mitigate this possibility, all links produced by AI provided code is checked for appropriateness of the link, fit for purpose of the code returned, appearance of malicious code characteristics such as call home, etc.

Because of the possibility of situation 2, code delivered by an AI system needs to be examined closely. To do so, in addition to the specific steps disclosed above for mitigating this type of attack, code delivered by AI systems should be subjected to the testing and simulation mechanisms described herein.

### AI System Perspective Implementation

The owner/operator of an AI system that can be used by code writers may want to provide services to its users that offer protection from this type of attack. To that end, before they put a new system, an upgraded system, etc. into service (situation 1) they associate an orchestrator with their AI system that exercises the system to identify these recurring types of hallucinations. Then filling in the files as described above. They will also want to use the orchestrator to test any code module that the AI system delivers containing code with link(s) for appropriateness of the link, fit for purpose of the code returned, appearance of malicious code characteristics such as call home, etc.

### Repository Perspective Implementation

The owner/operator of a repository may want to provide services to its users that offer protection from this type of attack. To that end, they associate an orchestrator with their repository and exercise a broad range of AI systems (currently in service, just coming into service, etc.) as described above to identify these recurring types of hallucinations that reference their repository. Then. filling the files identified on their repository as described above. They will also want to use the orchestrator to test any code module that their repository delivers in response to a link request for appropriateness of the link, fit for purpose of the code returned, appearance of malicious code characteristics such as call home, etc.

### Mid Network Orchestrator Perspective Implementation

The owner/operator of a mid network orchestrator may want to provide services to its users that offer protection from this type of attack. To that end, they create an orchestrator associated with their repository. Their orchestrator exercises a broad range of AI systems as described above to identify these recurring types of hallucinations. Then filling the files identified as described above. They will also want to use the orchestrator to test any code module that is delivered in response to a link request passing through the mid network orchestrator for appropriateness of the link, fit for purpose of the code returned, appearance of malicious code characteristics such as call home, etc.

### End User Perspective

A large end user organization using a single, or small number of tightly controlled, AI systems may want to protect itself from this type of attack and it may make economic sense for it to do so. In that case, the organization associates an orchestrator with their internal system/network and exercises the AI systems it uses as described above in situation 1 to identify these recurring type of hallucinations. Then filling in the files identified on their repository as described above. In case of situation 2, they will also want to use the orchestrator to test any code module that is returned to a coder in their organization in response to a link request for appropriateness of the link, fit for purpose of the code returned, appearance of malicious code characteristics such as call home, etc.

An individual coder, small organization, etc. may not have the resources to take proactive steps. In that case, it can use two mechanisms. First have an orchestrator test any outbound link request for appropriateness of the link request (this is also a step that large organizations should include in the mechanisms described above). Second have an orchestrator test any code module that is returned in response to a link request for appropriateness of the link, fit for purpose of the code returned, appearance of malicious code characteristics such as call home, etc.

### Need for Test and Simulation of All Code Generated by AI Systems

In addition to the specific mechanisms disclosed above for mitigating this type of attack, all code generated by AI systems should be subjected to the testing and simulation mechanisms described elsewhere in this document.

### Intellectual Property Leakage

Encapsulation, observation, and intervention is one way that AI can be used safely in a conductor/orchestrator network. Encapsulation limits the AI system to be only able to communicate with functions inside the capsule that contains it. That is, the AI system has no ability to communicate directly with the outside world. Observation determines if the AI system is trying to do something that can be characterized as a bad side effect. Intervention can be amongst other things, remediation. Remediation is preventing the AI system from actually accomplishing a bad side effect.

### Encapsulation

Encapsulation can be done with physical barriers, computer hardware, software, a combination of these, etc. With a physical barrier, there is a physical structure that encloses the AI system and any associated components. This physical structure prevents any interaction with the outside world.

In computer hardware encapsulation, a processor and associated memory, and/or a network of same, containing the AI system(s), and has only a single external hardware interface that goes directly to another processor and/or network of processors such that this second processor(s) has complete control of all external communication from/to the AI system. This second processor is configured to prevent any bad side effects from exiting to the external world.

A similar kind of encapsulation can be done in software. There are several ways to do it in software. They can be done singly and/or combined. The AI system(s) can be in the same system image such as an Operating System, Virtual Machine, Container, Bare Metal, storage system, etc. that has only one external interface directly to a software function that has complete control of all external communication from/to the AI system. This software function is configured to prevent any bad side effects from exiting to the external world. The software function can be in the same, and/or another, and/or a combination of them, system image such as an Operating System, Virtual Machine, Container, Bare Metal, storage system, etc. An embodiment disclosed below makes this possible.

A number of the same methods, or a combination of physical, hardware and software encapsulation methods can be used. There can be a hierarchy of encapsulations to provide defense in depth. Etc. For example, in some embodiments, hardware encapsulation is used to contain a software encapsulated AI system.

Encapsulation can be assisted by configuration(s) within the AI system itself including how the AI system is trained, which functions it is configured to perform, and how its inputs are structured.

### Observation

Observation is the process of determining for each AI system if the AI system is creating a bad side effect. This observation can be done with the conductor/orchestrator network. For example, in some embodiments, orchestrator 506 interacts with conductor 201, and orchestrators 202 to 207 using the negotiation/cooperation/coordination mechanism and the moving sum average histogram mechanism to identify behavior changes that indicate that the AI system has communicated with something outside its encapsulation and 506 takes steps to prevent further outside communication. In some embodiments, the detected external communication will trigger action by orchestrator(s) associated with the AI system, such as orchestrators 314, 315. Observation alarms can, or cannot, be subject to false positive filtering, root cause analysis, etc. In some embodiments, an orchestrator not directly associated with the AI system, such as orchestrators 311, 312, 313, 308, 316, 317, may generate the alarm.

Observation may be carried out by an orchestrator observing its own internal AI system; an orchestrator observing another orchestrator's AI system; a conductor observing an AI system contained, and/or encapsulated in an orchestrator(s); an orchestrater(s) observing an AI system contained, and/or encapsulated in a conductor(s); a metaconductor observing an AI system contained, and/or encapsulated in a conductor(s); a superconductor observing an AI system contained, and/or encapsulated in a metaconductor(s); etc. A superconductor coordinates with and optimizes a plurality of conductors. A metaconductor coordinates with and optimizes a plurality of superconductors.

### Intervention

Intervention includes preventing bad side effects from occurring. It can be done proactively (maintenance mode) or reactively (in response to an observation). When done in response to an observation, it is done in response to an alarm. In some embodiments, an alarm is processed by a false positive filtering algorithm before intervention is performed. In some embodiments, an alarm is processed by a root cause analysis algorithm before intervention is performed. In some embodiments, an alarm is processed by a false positive filtering algorithm and a root cause analysis algorithm before intervention is performed.

Choice of which kind of intervention to perform may be a result of: the type of alarm, and/or the types, and/or frequency of alarms from that instance of an AI system, and/or that class of AI system(s), etc. Such information may come from within the conductor/orchestrator network, and/or from external sources, and/or a combination of them. Intervention actions may or may not be the subject of negotiations and/or cooperation between parts of the conductor/orchestrator network. Intervention actions can include, but are not limited to deleting and/or blocking the communication by the AI system by its containing orchestrator, deleting and/or blocking the communication by the AI system by its associated orchestrator(s), deleting and/or blocking the communication the AI system by the associated conductor, updating the AI system(s), modifying the AI system(s), shutting down the AI system(s) within that orchestrator by that orchestrator, shutting down the AI system(s) in a group of orchestrators by each orchestrator, shutting down the orchestrator that contains the AI system, by a different orchestrator, shutting down the orchestrator by conductor, shutting down the AI system in that orchestrator by conductor, shutting down the AI system(s) in a group of orchestrators by conductor(s), shutting down the orchestrator by the conductor and replacing it with a new orchestrator, deleting and/or blocking the AI system's communication attempt by the conductor, shutting down the AI system in the conductor by the conductor, shutting down the conductor(s) containing AI system(s) by the metaconductor, shutting down the conductor by the metaconductor replacing it with a new conductor, and so forth for Superconductor, etc.

In some embodiments, choice of encapsulation method, observation method, and/or intervention method is affected by the particular way that an AI system(s) is deployed. In some embodiments, choice of encapsulation method, observation method, and/or intervention method is not affected by the particular way that an AI system(s) is deployed.

There are many types of intellectual property leakage that involve AI. Intellectual property leakage has to do with a concern that if proprietary information is input into an AI system as part of a request to an AI system, that proprietary data will be used for training the AI system and as a result may leak out to bad actors, be used by the AI system itself for purposes contrary to its owner's interest, get caught up in a hallucination, etc.

There are concerns that using AI systems to test systems in general, and/or cybersecurity aspects of systems in particular, may act to train the AI system to be a better attacker and that programing code requests and/or the resulting code can be used by the AI system to support cyber attacks. Yet, there is a real need to test cybersecurity against AI created cyberattacks and significant benefits in using AI in code development. Disclosed are mechanisms that allow these benefits to be captured while mitigating the negative side effects.

### Hardware Encapsulation Cybersecurity Testing Mitigation

Experts in AI warn against using AI systems to test mitigation tools out of a concern that such actions on AI systems can ‘teach’ them how to be better attackers. In the realm of cybersecurity, a dilemma arises: How do we protect against AI attacks without employing AI for testing, and training our personnel? One approach to address this challenge can be grounded in two fundamental phases:
A. Place the AI system in an isolated environment without access to the external networks.
B. Eliminate the AI system after usage.

To fulfill phase A, utilizing publicly accessible AI systems over the Internet is not viable. Instead, a dedicated, isolated hardware system is needed, often referred to as “air-gapped.” Moreover, AI systems possess a track record of coercing individuals into performing tasks beyond AI capabilities. In controlled laboratory settings, it is vital to continually train and observe staff against carrying out actions on behalf of the AI system, particularly outside the rigorously regulated lab environment. Additional controls, reminders, training initiatives, and active monitoring may be required.

Phase B. seeks to prevent AI systems from enhancing their attack skills. The key challenge is achieving this economically, given the significant investments in time and money involved in creating AI systems.

Once an AI system exists, it can be cloned with significantly less effort than the original development and training. A clone can be created for specific lab tests and subsequently destroyed. However, this process requires strict observation during destruction to ensure total removal and to prevent the system from self-cloning or hiding its clone. There has been published speculation about AI systems actively trying to prevent shutdown or creating a clone and hiding it.

FIG. 6A is a block diagram illustrating a system to physically secure an AI system in accordance with some embodiments. In the example shown, system 600 includes a physically secure facility 601. Inside the physically secure facility 601 is lab 602. Lab 602 is disconnected, shielded, etc. from the outside and has special physical access controls, procedures, etc. Inside the physically secure facility 601 is a master AI system 603 with an associated orchestrator 613 and staff and/or automated processes 604 (staff may use a device to communicate, however, the staff member is tracked and the device, location etc., are parameters of the staff member) and their associated orchestrator(s) 614. Staff/automated processes works with the Master GenAI via their associated orchestrators to create and install one or more clone AIs 605 and associated orchestrator(s) 615 inside lab 602. Subsequently, one or more end users 606 and their associated orchestrator 616 are able to make use of the one or more clone AIs 605. Orchestrators 618, 619 monitor the exterior communication (e.g., power, ethernet, phone, wireless networks, morse, light, or any other type of communication system), computing, etc. of the secure facility to mitigate any leakage. Orchestrators 618, 619 may determine whether there is any leakage using a behavioral analysis algorithm, such as a histogram behavioral analysis algorithm disclosed herein. Parameters associated with different components within system 600 may be monitored and corresponding counts may be determined. Orchestrators 618, 619 may implement a remediation based on the monitored behavior of the different components within system 600. Although FIG. 6 depicts two orchestrators monitoring the external environment of the secure facility 601, system 600 may include n orchestrators to monitor the exterior environment of the secure facility 601. In some embodiments, an orchestrator external to the secure facility is associated with an external conductor and/or a meta conductor. In some embodiments, an orchestrator external to the secure facility is not associated with an external conductor and/or a meta conductor.

There may, or may not, be a conductor(s) inside the facility, and/or inside the lab, and/or in a larger network that includes the facility, etc.

FIG. 6B is a flow diagram illustrating a process to physically encapsulate an AI system in accordance with some embodiments.

At 652, a physically secure facility is acquired.

At 654, a separate lab is created within that facility. The lab also has another layer of physical security. In addition, it is insulated against any electrical, optical, etc. communication with anything outside of the lab.

At 656, one or more external monitoring orchestrators are installed to alarm if any of the communication, computing, isolation, etc., established has been breached.

At 658, one or more staff orchestrators that can provide support for the operation of the facility and/or monitor the actions of the staff is installed.

At 660, staff are trained and observed to use the facility and the lab. It may start earlier or later, and it may occur in other steps, and/or it may go on continuously. The key point of training staff is to teach them not to be tricked by the AI to breach the AI's isolation. The key point of observation is to alarm if staff has been tricked and is trying to breach isolation.

At 662, a master AI system is acquired, and/or developed, and installed in the facility. An orchestrator is associated with the master AI.

At 664, a clone of the master AI system and an associated orchestrator are created. The orchestrator may help in the use of and/or monitor and/or observe, etc. the master AI system.

At 666, the clone and its associated orchestrator are installed in the lab. The orchestrator may help in the use of and/or monitor, and/or observe, etc. the clone. The orchestrator assures that the installation process does not leave any mechanism that the clone can use to communicate with anything outside the lab.

At 668, the end users are trained. The training can be done in the facility and/or in the lab with or without participation of the various orchestrators. Here again, the key point of training staff is to teach them not to be tricked by the AI to breach the AI's isolation.

At 670, the end user(s)'s orchestrator(s) are installed in the lab.

At 672, the end user(s) is admitted into the lab and is permitted to work in the lab.

At 674, the end user(s) finish their work and are detected leaving the lab. This may be detected by the end user orchestrator, the end user(s) inputting, and/or sensors detecting the end users leaving the lab, etc.

At 676, the clone is destroyed in response to detecting that the end user(s) has left the lab. The end user(s)'s orchestrator may send to the orchestrator associated with the clone a command to destroy the clone. In response to receiving the command, the orchestrator associated with the clone destroys the clone. In some embodiments, the clone is stopped. In some embodiments, a computer running the clone is powered down and a memory associated with the computer is wiped. In some embodiments, the computer running the clone and/or a portion of the computer running the clone is destroyed.

### Hardware Encapsulation for Other IP Leakage Mitigation

The same elements from FIG. 6A and the steps of FIG. 6B can be used to mitigate other types of IP leakage side effects of using AI. Examples include avoiding IP leakage in, and/or of:
Code development-avoiding: Training AI to better attack the resulting system, Leaking trade secrets, Leaking the look and feel of product(s), Etc.;
Product Specifications;
Advertising strategy and/or materials;
Sales and Marketing strategy and/or materials;
Financial Information;
Product defect(s) information;
Regulatory compliance information;
Legal information in general;
Legal counter party information;
Etc.

Hardware encapsulation also provides protection from AI hallucinations getting out of the lab. This can be important in mitigating all of the different negative side effects hallucinations can have.

### Hardware Encapsulation Using Personal Computers

Edge devices (e.g., personal computers, tables, smartphones, smart watches, wearables, etc.) are getting more powerful. Today some high end machines have the power to run powerful AI systems in a single user mode. There are also a growing number of open source AI systems available for download. These capabilities are likely to increase. This means that end users are able to construct hardware encapsulation systems in their own offices using the same or similar techniques as above.

### Software Encapsulation

Similar to hardware encapsulation is software encapsulation. In software encapsulation, software mechanisms are used to achieve control of AI negative side effects. The mechanisms are applicable to areas of use (domain, application area, etc.) that include, but are not limited to: cyber security; physical security; all types of security; network operations; computer operations; all types of operations; storage; record storage; mechanical machine operation; networks of mechanical machines; combinations of computers and machines; combinations of networks and machines; systems and/or networks of manual (people) systems/operations; combinations of cyber systems, mechanical systems and manual (people) systems; etc.

Mechanisms to implement AI while mitigating negative side effects using orchestrators and/or conductors are disclosed. The techniques may be used in or with a combination of an AI system and an orchestrator, multiple AI systems and an orchestrator, an AI system and multiple orchestrators, multiple AI systems and multiple orchestrators, etc. The term orchestrator may refer to a single orchestrator, multiple orchestrators, a network of orchestrators, a single conductor, multiple conductors, a network of conductors, a combination of orchestrator(s) and conductor(s), etc.

Once negative side effects are mitigated, there are many advantages of combining AI systems with orchestrators including minimizing AI latency and improving effectiveness, while maintaining operational efficiency. These advantages flow from a number of unique capabilities of orchestrators and orchestrator/conductor networks including: the ability to operate effectively at the network edge, network middle, data center, in a moving vehicle, in a specialized hardware backpack, and to be moved between these without reprograming; the ability to provide just the data needed, when needed, where needed, as soon as it occurs, etc.; the ability to operate with any kind of AI system and/or combinations of a number of AI systems all of the same type, or of varying types, etc.

In some embodiments, a small footprint model is provided inside, or with, orchestrator(s). A small footprint AI system is one that has been created with the intent of minimizing demands for system resources while providing acceptable performance. Examples of system resources include the processing power of the processor, the amount of various types of memory, the power consumed, etc. Performance is typically measured along two axes: the speed of output—called inference performance, that is, how fast it generates a response to a prompt—and the quality of the output—referred to as accuracy, that is, the “intelligence” of the response. There are a number of ways that this can be achieved including reducing the number of parameters & layers, etc., focusing/reducing the training data on a task(s), focusing fine-tuning on resource limitation, reducing the number of bits used to represent weights in the model (quantization), etc. For some time, it has been assumed that a larger number of these things equals a more powerful AI system. Recent research indicates that this may not be true—that different ways of structuring, choosing, implementing, etc. produce more powerful AI systems, especially if the AI system is trained for a specific limited domain. The AI system footprint may also be reduced by focusing it on the cybersecurity problem space, other problem spaces, and/or in other ways.

One of a number of intents in creating a small footprint AI system, is to make it technically and financially feasible to combine it (them) with an orchestrator. The orchestrator and AI system may be operating in the same location, or they may be operating in different locations. The orchestrator(s) and AI system(s) could be operating in the same system image (O/S, Container, VM, etc.) as the sub-system the orchestrator is associated with. It could be operating in a different but related system image (O/S, Container, VM, etc.). It could, without reprogramming, be moved to operate at the network edge; in the middle of the network; in a moving vehicle, in a data center, etc. It has special advantages for working at the network edge including but not limited to in vehicles, office systems, PC's, phones, appliances, factory automation devices, etc. While a data center could operate a large footprint AI system (e.g., currently between 10\hat{ }12 to 10\hat{ }22 parameters), there is an advantage of having a single small footprint system that could be moved out of the data center into the network without reprogramming. Also, it might not be technically and financially feasible to operate many instances of the same large model AI system and/or multiple large model AI systems in a single data center—for example to have a large number of orchestrators/AI systems associated with a large number of data center sub-systems and/or applications, etc. It may also be more efficient to have multiple small footprint AI systems each focused on a narrow domain(s). Examples of such narrow domains include but are not limited to cybersecurity, network operations, hallucinations, etc. Operating many instances of the same small model LLM and/or multiple small model LLMs in a single data center is technically and financially feasible, while doing that with large model LLM(s) may not be.

In some embodiments, the orchestrator(s) and its AI system(s) could operate effectively in specialized hardware as a backpack, such as mobile base station included in a backpack. These could have specialized AI processors, system architectures, etc. that provide special advantages for AI systems. Examples of advantages include, but are not limited to, lower latency, lower power consumption, larger parameter sets, better quality results, etc. The specialized processors/architectures could be the same as used in the central site systems; specialized ones developed for use outside of data centers such as those developed for autonomous vehicle operation, end points, etc.; ones developed specifically for this purpose; etc. These backpack orchestrator/AIs could be at the network edge; in the middle of the network; in a vehicle, in a data center, etc. They offer additional advantages including but not limited to simulation, case of management (limited number of standard configurations); ease of installation; etc. Ease of installation may be of particular importance in vehicle (including: aircraft, water craft, rockets, spaceships, satellites, etc.).

Although a Data Center could operate a large footprint AI system, there is an advantage of having single or multiple backpack system(s) that could be moved out of the Data Center into the network without any changes. Also, it might not be technically and financially feasible to operate many instances of the same large model AI system and/or multiple large model AI systems in a single data center. While operating many instances of the same backpack AI/orchestrator and/or multiple backpack AIs/orchestrators in a single data center is technically and financially feasible.

In some embodiments, a mid-size AI system(s) is located either inside an orchestrator(s) and/or is associated with an external orchestrator. The mid-size AI system(s) has more parameters than the small footprint model, but does not have the number of parameters that are in the large footprint AI model. These embodiments have all the advantages cited above with the addition of being particularly well suited to placement in the mid network region.

In some embodiments, a large footprint AI system is located in and/or associated with an orchestrator(s). Such embodiments, have all the advantages cited above. As processor, architecture, etc. evolution proceeds, and capabilities continue to increase, it may be technically and financially feasible to have large footprint AI system orchestrator(s) combinations operating in all areas of the computing, storage, and communications systems, as well as the data center.

In all of the above descriptions, benefits, etc. a conductor can be substituted for an orchestrator as well as combinations of conductor(s) and orchestrator(s) with AI systems in or associated with them.

### AI Systems Inside Conductors and Orchestrators

One embodiment of software encapsulation is shown in FIGS. 7, 8 and 9. FIG. 7 is a block diagram illustrating a system to encapsulate software in accordance with some embodiments. In the example shown, system 700 depicts a simplified version of a conductor 701 and an orchestrator 715. In some embodiments, conductor 701 is conductor 201. In some embodiments, orchestrator 715 is orchestrator 204, orchestrator 205, or orchestrator 206.

Conductor 701 includes network interface 702 that allows conductor 701 to communicate with orchestrator 715 via connection 704. Connection 704 may be a wired connection, a wireless connection, or a combination thereof. Conductor 701 also includes library 703. Library 703 includes the objectives, algorithms, and constraints associated with an active or potentially active orchestrator or conductor in the conductor/orchestrator network (e.g., the combination of orchestrators and conductor of FIG. 2).

Orchestrator 715 includes a first subsystem 716 that maintains a local library of objectives available for use by orchestrator 715, a second subsystem 717 that maintains a local library of algorithms available for use by orchestrator 715, and a third subsystem 718 that maintains a local library of constraints available for use by orchestrator 715. Orchestrator 715 includes an internal API 719. Internal API 719 provides the interface to low level orchestrator components including conductor/orchestrator network interface 710, local data store 711, bridge 712, etc. Bridge 712 provides translation between the umbrella model and the local data model of the underlying system component 713 with which the orchestrator 715 is associated. The umbrella data model is a superset of the local data models associated with a plurality of underlying system components and acts as a lingua franca. Internal API 719 is similar to the one that exists in a conductor(s) where similar mechanisms can be used in conjunction with it.

FIG. 8 is a block diagram illustrating a system to encapsulate software in accordance with some embodiments. System 800 is similar to system 700 except that AI system 801 is included in library 703 and AI system 811 is included in the second subsystem 717. AI system 801 and/or AI system 811 may be a reduced functionality version and/or one trained specifically on only the intended domain, intended functionality, a full functionality system, a small footprint system (having less than or equal to a first threshold number of parameters, and/or other methods of reducing the footprint), a medium footprint system (having more than the first threshold number of parameters and less than or equal to a second threshold number of parameters and/or other methods of reducing the footprint), a large footprint system (having more than the second threshold number of parameters and/or unconstrained in other ways), etc. The AI system may be further optimized in other ways for the domain, functionality, etc. that it is intended to address. AI system 801 may be active and/or inactive. Depending on the objectives, algorithms and constraints associated with conductor 701, AI system 801 may be on (functioning in the conductor), ready to be turned on (e.g., standby), being used for downloading to orchestrators, turned off, deleted, a combination of these, etc. For example, in some embodiments, the conductor only maintains a master AI system from which it clones and downloads instantiations to particular orchestrators. In these embodiments, the AI system is never functioning as an active AI system in the conductor. Depending on the orchestrator's objectives, algorithms, and constraints associated with orchestrator 715, AI system 811 may be on (functioning in the orchestrator), ready to be turned on, in sleep mode, turned off, deleted, a combination of these, etc. AI system 811 may be downloaded to, turned on, ready to be turned on, turned off, deleted, a combination of these, etc. by conductor 701 and/or by the orchestrator 715. For example, in one realization, AI system 811 is kept in sleep mode until it is needed and then turned on. This can be done for a variety of reasons including to minimize power consumption. This and other modes may be used for other purposes.

In some embodiments, the size of the footprint system changes based on a location of the orchestrator. In some embodiments, the size of the footprint system changes from a small footprint system at a first orchestrator location to a medium footprint system at a second orchestrator location. In some embodiments, the size of the footprint system changes from a small footprint system at a first orchestrator location to a large footprint system at a second orchestrator location. In some embodiments, the size of the footprint system changes from a medium footprint system at a first orchestrator location to a small footprint system at a second orchestrator location. In some embodiments, the size of the footprint system changes from a medium footprint system at a first orchestrator location to a large footprint system at a second orchestrator location. In some embodiments, the size of the footprint system changes from a large footprint system at a first orchestrator location to a medium footprint system at a second orchestrator location. In some embodiments, the size of the footprint system changes from a large footprint system at a first orchestrator location to a small footprint system at a second orchestrator location.

FIG. 9 is a block diagram illustrating a system that includes three simplified versions of inter-related environments in accordance with some embodiments. In the example shown, system 900 includes a development environment 901, an operating environment 911, and a simulation environment 921.

In some embodiments, meta conductor 940 interfaces with a conductor associated with each environment. For example, meta conductor 940 may interface with conductor 906, conductor 916, and/or conductor 926. In some embodiments, having a conductor (e.g., conductors 906, 916, 926) in an environment is optional. In some embodiments, system 900 includes one or more orchestrators 930 that are external to the development environment 901, the operating environment 911, and/or the simulation environment 921. One of the one or more external orchestrators 930 may be associated with meta conductor 940. The one or more orchestrators 930 are configured to monitor the to/from external orchestrators 902, 912, 922. The one or more orchestrators 930 may determine whether there is any abnormal behavior (e.g., leakage) associated with development environment 901, operating environment 911, and/or simulation environment 921 using a behavioral analysis algorithm, such as a histogram behavioral analysis algorithm disclosed herein. Parameters associated with environments 901, 911, 921 may be monitored and corresponding counts may be determined. The one or more orchestrators 930 may implement a remediation based on the monitored behavior of the different components within environments 901, 911, 921.

Development environment 901 includes conductor 906, a to/from external orchestrator 902, an AI system encapsulated orchestrator 903, a staff orchestrator 904, and one or more staff members 905. Development environment 901 may include other elements that are not shown.

Simulation environment 921 includes a to/from external system orchestrator 922. In some embodiments, simulation environment 921 includes conductor 926. The to/from external system orchestrator 922 is associated with one or more simulated underlying system components (not shown).

Operating environment 911 includes a to/from external system orchestrator 912. In some embodiments, operating environment 911 includes conductor 916. The to/from external system orchestrator 912 is associated with one or more actual underlying system components (not shown).

Development environment 901 may include some or all of the elements of the conductor/orchestrator network shown in FIG. 2. Operating environment 911 may include some or all of the elements of the conductor/orchestrator network shown in FIG. 2. Simulation environment 921 may include some or all of the elements of the conductor/orchestrator network shown in FIG. 2.

There are many domains in which systems 700, 800, 900 and components of systems 700, 800, 900 can be implemented.

FIG. 10 is a flow diagram illustrating a process to test and develop code in accordance with some embodiments. In the example shown, process 1000 may be implemented by orchestrators included in a plurality of different environments, such as orchestrators 902, 912, 922.

At 1002, a natural language specification of one or more desired objectives, one or more desired algorithms, and/or one or more desired constraints is received. The natural language specification (e.g., text, graphics, etc.) may be received at an orchestrator, such as staff orchestrator 904, from staff, such as staff 905, or other person. In some embodiments, some or all of the AI system and/or some or all of the conductor/orchestrator elements in FIGS. 7, 8 and 9 are used in the flow shown in FIG. 10 to translate sets of objectives, algorithms and constraints requested by staff using natural language into tested code that can be used in conjunction with the API (7-9). If the natural language specification is unclear (e.g., has internal contradictions), the orchestrator may request for clarification, prompt the staff to revise the natural language specification, walk the staff through a process of generating the natural language specification, etc.

At 1004, one or more AI systems associated with the orchestrator convert the natural language specification into code that can interface to the orchestrator's internal API, such as internal API 719.

At 1006, a copy (clone) is made of the current configuration of some, or all, of the orchestrators and conductor(s) in the operating environment. For example, in some embodiments, the conductor in operating environment 911 creates a copy and delivers it through its to/from external orchestrator 912 to development environment 901. The development environment 901 via to/from external orchestrator 902 delivers it to to/from external orchestrator 922 in the simulation environment 921. Staff in a development environment, via a computing device (e.g., server, computer, smart device, or any other type of computing device), may trigger the copy to be made. Actual underlying components may or may not be in the simulation environment. Underlying components may or may not also be simulated. If simulated, they may be simulated by their associated orchestrators, a separate code module, a combination of the two, etc. For example, in some embodiments the underlying elements are 208, 209, 210, 211, 212, etc.

At 1008, the clone of the current configuration is installed in the simulation environment. An orchestrator associated with the staff (e.g., staff orchestrator 904) may send to a to/from external orchestrator in the development environment (e.g., to/from external orchestrator 902) a command to install the clone in the simulation environment. The to/from external orchestrator in the development environment coordinates with the to/from external orchestrator in the simulation environment (e.g., to/from external orchestrator 922) to install the clone of the current configuration in the simulation environment. In some embodiments, this coordination step is performed by a meta conductor, such as meta conductor 940. In some embodiments, this coordination step is accomplished through cooperation between a conductor in the development environment, such as conductor 906, and a conductor in the simulation environment, such as conductor 926. Cooperation can be accomplished via the negotiation, cooperation, and coordination mechanism, by a special mechanism created for this purpose, a combination of these, etc. For example, in some embodiments, staff in the development environment through the development and operational to/from external orchestrators trigger the creation of the clone and its transfer to the development environment. Then, staff in the development environment through the development and simulation to/from external orchestrators trigger the transfer of the clone to the simulation environment. This process can be automated. But there is value in keeping it manual to reduce the probability of AI created negative side effects in the process.

At 1010, the developed code is tested in the simulation environment. Testing may include using some or all of the mechanisms disclosed elsewhere in this document to control for AI hallucinations, manipulation, etc., and/or other code checking/testing tools. For example, in some embodiments, the code is subjected to the gibberish testing mechanism disclosed above. Other realizations will use the mechanisms disclosed herein. Simulation may include running the conductor/orchestrator network and underlying system components and looking for behavior of the system that is out of specification, unusual, problematic, etc. The simulation environment also provides for installing the code in the simulated network and running the network under various scenarios while observing the network's reaction(s) with and without the new code looking for behavior of the system that is out of specification, unusual, problematic, etc. Today's large, complex and volatile networks are particularly susceptible to small changes in one corner of the network causing unforeseen dramatic consequences in other parts. Thus, hallucinations, quality problems, etc. in the new code can have very negative consequences. Testing the code in the simulated environment mitigates these negative consequences.

Testing may or may not involve code review by staff members with the same objectives as the automated simulation. Thus, testing may be by simulated testing only, by staff code review only, by a combination of simulated testing and code review, etc.

At 1012, the code is installed in the operating environment. Transferring the code between all three environments is accomplished by the to/from other system orchestrators 922, 902, 912, and/or another mechanism. Conventional methods for ensuring that the code has been transferred without error are used such as MAC (Message Authentication Coding), etc.

At 1014, operation of the code is observed and documented by the one or more orchestrators and/or the one or more conductors in the operating environment. Monitoring may vary in intensity depending on objectives, algorithms and constraints. In some embodiments, the objectives, algorithms, and constraints will be influenced by time installed, performance observed, outside factors, etc. For example, in some embodiments, code is loaded into a particular orchestrator. The conductor takes samples of that orchestrator's internal data and carefully analyses them. Analysis is done by comparing histograms of the samples with histograms of the samples from before the new code was running and with running sum average histograms. For the first 5 seconds after the new code is operating, samples are taken every 2 milliseconds. For the next 10 seconds samples are taken every 10 milliseconds. For the next 20 seconds, samples are taken every 100 milliseconds. For the next 5 minutes, samples are taken every second. For the next hour samples are taken every minute. For the next day, samples are taken every hour. For the next month, samples are taken every day. And so forth.

Similar mechanisms to those shown in FIGS. 7, 8, 9 and 10 can be used for other functions in part or in whole in cybersecurity such as, but not limited to attack identification and attack remediation. They can also be used to convert natural language (text, graphics, voice, etc.) into code that can interface with the API. For example, in some embodiments, the mechanisms are used to identify particular parameter values that have been associated with an attack. Such parameter values may be IP addresses, URLs, etc. In some embodiments, the mechanisms can be used to develop and test code intended to run in other applications than conductor/orchestrator networks.

Software Encapsulation with an External Orchestrator

FIG. 11 is a block diagram of a system to perform software encapsulation in accordance with some embodiments. Software encapsulation may be performed by an orchestrator and/or a conductor external to the AI system. FIG. 11 is similar to FIG. 2, except that FIG. 11 includes orchestrator 1113 and AI system 1114. Conductor 201 and orchestrators 202, 203, 204, 205, 206, 207 may operate in a similar manner as the external monitoring orchestrators disclosed in the hardware encapsulation (e.g., orchestrators 618 and 619) and/or there may be additional dedicated orchestrators functioning like 618 and 619. There may or may not be a simulation environment, a meta conductor, external orchestrators may, or may not, be associated with the meta conductor, etc.

The external orchestrator(s) seeks to monitor and if necessary restrict communications between the AI system, the rest of the underlying networks and external networks to limit negative side effects.

### Combinations of Internal and External Software Encapsulation

There may be combinations of external and internal encapsulation. In some embodiments, AI system 801 and/or AI system 811 is combined with AI system 1114.

### AI Software Encapsulation In Other Domains

Similar mechanisms to those shown in FIGS. 7, 8, 9, 10, AI software encapsulation can be used for other functions in part or in whole in a wide variety of other domains. Below is a brief incomplete list of examples.

One area is the use of software encapsulation of AI to extend and enhance orchestrator/conductor functionality such as, but not limited to, the following. Today's large complex and volatile cyber networks can be difficult to manage. Previously disclosed and patented mechanisms for enhancing efficiency and self healing can be further enhanced.

Hallucination mitigation mechanisms disclosed earlier in this document can be further enhanced. By mitigating the risk of hallucination, specialized uses in a broad range of industries and government functions are opened up. For example, automated trading systems where a single hallucination could be financially catastrophic.

### AI Software Encapsulation and Concerns About AI Getting Out of Human Control

Researchers have been stating concerns and in some cases sounding alarms about the potential for AI systems to get out of human control. Some see this as possibly creating catastrophic disasters sufficient to end the human race. Concerns about AI systems getting out of human control are avoided by the conductor/orchestrator network providing flexible ways for manual intervention. This is accomplished by having staff, end users, etc. as fundamental parts of the underlying system(s), and according to objectives, algorithms, and constraints allowing people to intervene in part, in whole, etc. in any or all of the functions being performed by encapsulated AI systems.

### S2-D2 Response to AI Changing the Balance Between Attacker and Defender

The fact that cyber attackers now have access to AI created attacks has two important consequences. The speed with which new, never before seen, attack types are created is dramatically increasing. The technical sophistication required to launch an attack is dramatically decreasing. Now, a technically unsophisticated attacker can create an attack that previously only the extremely technically sophisticated staff of a nation state could create. These emerging attacks can be characterized as dynamic.

The majority of currently deployed cyber defense tools can be characterized as static. That is they use previously determined and specified patterns to recognize attacks and previously determined/specified responses to remediate the attacks. They can be characterized as Static attack ID and Static remediation. Or as S2. They also tend to be central site. That is the S2 functionality is performed in a central computing resource. They may have distributed components. But those distributed components are primarily functioning to capture and deliver data to the central site.

The orchestrator/conductor mechanisms disclosed herein are dynamic in nature. That is, they do not use previously determined patterns. Instead, they use dynamic mechanisms to find attacks. They do not use previously determined responses to remediate attacks. Instead, they use dynamic mechanisms to determine the best way for that particular attack, in that particular network, at that particular time to remediate the attack. Thus, they can be characterized as Dynamic attack ID and Dynamic remediation. Or as D2 systems.

It is tempting to think that the world can move immediately to this D2 set of mechanisms. But, industry, government and individuals have a large sunk investment in S2 systems (tools process, procedures, playbooks, etc.). Also, attackers have a large sunk investment in S2 attack systems. For a while there will be continuing S2 attacks. Therefore, it is efficient to make use of all or potions of what has been developed for and with S2 while making the transition to dynamic. This approach can be characterized as an S2-D2 system approach.

An S2-D2 system approach is implemented in the orchestrator/conductor network in two ways. In the first, (see FIG. 12) orchestrators are associated with the existing S2 systems bringing them into the dynamic orchestrator/conductor network. In the second (see FIG. 14) the predetermined patterns (often called playbooks) are loaded into the algorithm libraries of orchestrators and conductors and executed along with the dynamic algorithms there.

One of the ways, but not the only way, that investments in S2 systems can be used and made better by S2-D2 systems is in inter-tool coordination. Current S2 cyber defense systems tend to be very good within the well-defined limits of their respective focus. That is, they work well within the limited functionality they address. However, they don't cooperate very well with other tools-especially other tools from different vendors. In some cases, S2-D2 systems can make underlying S2 systems achieve better results by creating cooperation between them. For example, two firewalls from two different vendors don't cooperate. In one use case experienced by a financial services company there were two firewalls from different vendors. One is responsible for user logon and the other for intrusion protection. A brute force attack on the user authentication system resulted in overall system shutdown. If the login system could tell the intrusion detection system the IP address the attack was coming from, the intrusion detection system could block the attack and the overall system would operate. The addition of the conductor/orchestrator network provides the missing communication/cooperation and restores the underlying network.

As seen in FIG. 12, underlying network 1201 is being defended by one or more S2 defensive system(s) 1202 configured to protect the underlying network 1201. An S2 defensive system may be fully S2, or it may have some dynamic systems. Orchestrator 1204 is associated with the one or more S2 defense systems 1202. One or more orchestrators 1203 are associated with other subcomponents of the underlying network 1201 (such as 208 to 212). In some embodiments, there is one orchestrator per S2 defense system. In some embodiments, there is one orchestrator associated with a plurality of S2 defense systems. In some embodiments, conductor 1206 is used in place of the one or more orchestrators 1203. 1206 is the conductor associated with the orchestrators which may or may not contain portions of the S2 system(s). For example, in some embodiments, some of the orchestrators 1206 is associated with contain S2 and some do not. Not shown for the ease of the reader is that a conductor(s) may be associated with a sub component(s) directly. In some embodiments, a conductor acts as both a conductor and an orchestrator.

FIG. 14 is a block diagram illustrating a system to encapsulate software in accordance with some embodiments. In the example shown, system 1400 is similar to system 700 except that the library 703 of conductor and the subsystem 717 of the orchestrator 715 include S2 pattern-based algorithms (e.g., a playbook) and D2 dynamic algorithms.

Adding AI capability and other features described above and below to the conductor/orchestrator network(s) while simultaneously controlling those AI elements such that they do not cause bad side effects for the conductor/orchestrator network and/or the underlying network it is orchestrating can further improve the three sets of cybersecurity functions described above, as well as providing other benefits, and/or increasing existing benefits, and/or controlling bad side effects, and/or eliminating bad side effects, etc. It can do this by improving problem identification, problem remediation, improved efficiency of the underlying network, improved efficiency of the conductor/orchestrator network, improved security of the conductor/orchestrator network, etc. It can:
Create a more powerful defense against AI attacks
Make it easier for non-programming staff to create and/or modify objectives, algorithms, and constraints

### Defending AI's From Attacks

The mechanisms for protecting an AI system during normal operation are similar to those described herein for other systems. Early indications of AI system cybersecurity vulnerabilities have appeared to surface outside of normal operation. As in previous discussions, problems can be the result of an operational failure or a cybersecurity attack. Defending an AI from an attack includes identifying security and operational problems in AI Systems themselves and remediating them. This includes, but is not limited to protecting AI systems from corruption both from intentional via cyber-attack and unintentional during: (i) model design, (ii) development and testing including coding, (iii) training, (iv) operation, (v) maintenance, (vi) cloning, (vii) shut down, (viii) end of life, (ix) back-up, (x) archiving, (xi) etc.

Mechanisms disclosed herein perform conformance testing and remediation to achieve conformance. During each of the life cycle stages i. to xi. above, requirements documentation that has been prepared as an integral part of development, operations, etc. is used. These requirements documentation becomes a source of truth. At each life cycle stage, the conductor/orchestrator network observes behavior of the underlying subsystem(s) and/or system(s). For example, orchestrators observe training data input both during initial training and on-going in operation training to make sure that the streams of training data conform to the specifications the system designers have created.

In one embodiment, if a subsystem and/or system is deviating from requirements—for example doing something it is not supposed to do, and/or not doing something it is supposed to do, etc.—an alarm is created. In another embodiment, during a life cycle stage, successfully passing a conductor/orchestrator network observation without an alarm(s) that is unresolved, may be required for an AI system to move from that life cycle stage to another life cycle stage. Alarm and stage passing may be combined. They may also be combined with the stage interaction mechanisms disclosed below and in preceding sections of this document.

Furthermore, conductor/orchestrator network(s) may create interactions between life cycle stages. For example, in some embodiments, separate conductor/orchestrator networks are created for each life cycle stage. In some embodiments, a single conductor/orchestrator network is created and used across all life cycles. In some embodiments, a first conductor/orchestrator network is created for one or more life cycle stages and one or more other conductor/orchestrator networks are created for the one or more remaining life cycle stages. In all cases, it is possible for conductor/orchestrator network information relative to one life cycle stage to be combined with other conductor/orchestrator network life cycle(s) information.

Based on information, objectives, algorithms, and constraints, conductor(s) and/or orchestrator(s) in the conductor/orchestrator network with or without AI can make decisions on subsystem installation, configuration, initiation, problem identification, false positive filtering, root cause analysis, determining if the problem is a result of a cyberattack or an operational failure, problem resolution, conformance testing, conformance auditing, conformance reporting, conformance remediation to come into compliance, vulnerability testing to identify and remediate potential exposure(s), efficiency optimization, protection optimization, back-up, disaster recovery, subsystem shut down, system shut down, etc.

Protecting AI systems may also require protecting (from corruption and other threats) other systems that can be used to help AI systems with authentication, validation, auditing, etc. Examples include, but are not limited to, other systems that act as a source of truth.

### Preventing IP Leakage Through Intervention

Organizations may wish to control access to AI to control IP leakage. To this end, they may wish to limit access to some or all AI systems, parts of AI systems, particular uses of AI systems, etc. by some or all members of the organization, some or all people outside the organization, a combination of these, etc. and some or all portions of the underlying system in addition to people who are organization members. For example, but not limited to, if an organization decides to restrict security development, testing and training to a secure hardware encapsulated lab as disclosed above, the organization may want to prevent attempted online AI access for these purposes.

To limit damage and for other reasons, in one embodiment, for controlling access to external AI systems, orchestrators 202, 203 and 207 and conductor 201 can block access by some or all of organization members, such as end users 208 and staff 209. Specific individuals, specific groups, specified job functions, geographic locations, etc. may be blocked. Access to and/or from the rest of the underlying system 210, 211, 212, etc. may be blocked. Access from external people or system(s) (including AI system(s)) to any portion of the underlying system including organization members may be blocked by orchestrator 207. Access blockage may consist of blocking all traffic, certain types of traffic, certain times of day, certain conditions, etc. In some embodiments, to limit damage access to external AI systems is controlled by orchestrator(s) 205 configuring security tools such as firewalls to block access by some or all of organization members, such as end users 208 and staff 209.

In some embodiments, AI system 1114, AI system 801, or AI system 811 may be intended for external use, for internal use, a combination of the two, etc. If completely or partially external, it may be available on the public internet, a private network, the Dark Web, a combination of these, a limited set of these, etc. If the AI system is external in whole or in part, orchestrator 207 and/or conductor 201 can block organization member access to the AI system(s) and block access from the AI system(s) to all portions of the underlying system including organization members. In another realization, for controlling access to internal AI systems, orchestrator(s) 205 may configure security tools such as firewalls to block access by some or all of the external sources. This may or may not be combined with the other embodiments. In another embodiment, if the AI system is internal in whole or in part, orchestrators 202, 203, 1113, 715, and conductor 701 can block any portion of the underlying system, including organization members, access to the AI system(s) and access from the AI system to all portions of the underlying system including organization members.

As discussed earlier, orchestrator/conductor networks can act to prevent corruption of training data during operation of AI systems. For example, in some embodiments, orchestrator 314 prevents what appear to be requests coming to AI system 304 from introducing compromising data to AI system 304.

### Orchestrator/Conductor Performing Combinations of Functions

In the sections above, orchestrator/conductor mechanisms focused on particular measures (problems, tasks, functions, domains, etc.) were disclosed. Depending on objectives, algorithms, and constraints orchestrators/conductors can perform multiple measures (functions). The choice of which one(s) is a function of the decisions concerning objectives, algorithms, and constraints. Examples of combinations include, but are not limited to one or more of, and/or combinations of measures focused on:
Security; Operations; Hallucination mitigation; Other.

### CONCLUSION

Although the foregoing embodiments have been described in some detail for purposes of clarity of understanding, the invention is not limited to the details provided. There are many alternative ways of implementing the invention. The disclosed embodiments are illustrative and not restrictive and cover a very broad range of domains including but not limited to: Cybersecurity, Legal Profession, Military/Diplomacy, Government in general, Industry in general, Critical infrastructure, Human Resources/Recruiting, Medical, etc.

What is claimed is:

1. A system, comprising:
a communication interface; and
a processor coupled with the communication interface, wherein the processor is configured to:
implement one or more objectives, one or more algorithms, and one or more constraints of an orchestrator with which the processor is associated, wherein the orchestrator is associated with an AI-based algorithm; and
based on one or more policies to improve a performance of the orchestrator, move via the communication interface the orchestrator to a different part of the system.

2. The system of claim 1, wherein the AI-based algorithm has a number of parameters, layers, and/or bits used to represent weights in a model.

3. The system of claim 1, wherein the orchestrator is part of an orchestrator/conductor network.

4. The system of claim 3, wherein the orchestrator/conductor network determines to move the orchestrator.

5. The system of claim 3, wherein the orchestrator/conductor network determines to create a new orchestrator.

6. The system of claim 3, wherein a conductor in the orchestrator/conductor network is capable of assuming a plurality of functions associated with the orchestrator.

7. The system of claim 1, wherein a state of the AI-based algorithm is based on the one or more objectives, the one or more algorithms, and the one or more constraints associated with the orchestrator.

8. The system of claim 7, wherein the state of the AI-based algorithm is turned on, sleep mode, turned off, or deleted.

9. The system of claim 1, wherein the orchestrator is encapsulated in a development environment.

10. The system of claim 9, wherein the orchestrator is moved from the development environment to a simulation environment.

11. The system of claim 9, wherein the orchestrator is moved from the development environment to an operating environment.

12. The system of claim 1, wherein the orchestrator is configured to receive a natural language specification of one or more desired objectives, one or more desired algorithms, and/or one or more desired constraints.

13. The system of claim 1, wherein the orchestrator is configured to translate the natural language specification into code interfacing to an internal applications programming interface associated with the orchestrator and/or conductor.

14. The system of claim 13, wherein the processor is configured to clone the orchestrator.

15. The system of claim 14, wherein the cloned orchestrator is the orchestrator moved to the different part of the system via the communication interface.

16. The system of claim 15, wherein the different part of the system is a simulation environment.

17. The system of claim 13, wherein the code is tested in the simulation environment for artificial intelligence hallucinations and/or manipulation.

18. The system of claim 17, wherein the code is tested for gibberish.

19. The system of claim 17, wherein the tested code is installed in an operating environment via a second orchestrator associated with the simulation environment in coordination with a third orchestrator associated with the operating environment.

20. The system of claim 1, wherein the one or more policies are based on security, reliability, performance, and/or effectiveness of an AI system, a conductor/orchestrator network, and/or an underlying network.

21. The system of claim 1, wherein the AI-based algorithm is focused on a particular domain.

22. The system of claim 21, wherein the particular domain is cybersecurity, network operations, hallucinations, legal, medical, education, government, military, enterprise, and/or source of truth.

23. The system of claim 1, wherein the orchestrator is associated with an end user, is a mid-network orchestrator, is associated with an AI system, or is associated with a source of truth.

24. The system of claim 1, wherein the one or more policies is based on reducing data leakage.

25. The system of claim 1, wherein the orchestrator is implemented in a backpack.

26. The system of claim 1, wherein a plurality of the orchestrator is deployed in a data center.

27. The system of claim 1, wherein the AI-based algorithm has a number of parameters less than or equal to a first threshold.

28. The system of claim 1, wherein a size of the AI-based algorithm changes when the orchestrator is moved to the different part of the system.

29. A method, comprising:
implementing one or more objectives, one or more algorithms, and one or more constraints of an orchestrator with which a processor is associated, wherein the orchestrator is associated with an AI-based algorithm; and
based on one or more policies to improve a performance of the orchestrator, moving via the communication interface the orchestrator to a different part of a system.

30. A computer program product embodied in a non-transitory computer readable medium and comprising computer instructions for:
implementing one or more objectives, one or more algorithms, and one or more constraints of an orchestrator with which a processor is associated, wherein the orchestrator is associated with an AI-based algorithm; and
based on one or more policies to improve a performance of the orchestrator, moving via a communication interface the orchestrator to a different part of a system.
